(19) United States
(12) Patent Application Publication
(10) Pub. No.: US 2026/0229985 A1
(43) Pub. Date: Aug. 6, 2026

(54) POWER CONVERTER

(71) Applicant: Infineon Technologies Austria AG, Villach (AT)

(72) Inventors: Johann Walter KOLAR, Zurich (CH); Davide BIADENE, Vicenza (IT); Jonas Emanuel HUBER, Aarau (CH); Matthias Joachim KASPER, Villach (AT); Gerald Josef DEBOY, Klagenfurt (AT)

(21) Appl. No.: 19/462,596

(22) Filed: Jan. 28, 2026

(30) Foreign Application Priority Data
Jan. 31, 2025 (DE) 102025103739.6

(51) Int. Cl. H02M 1/15; H02M 1/00; H02M 7/217; H02M 7/219; H02M 7/25

(52) U.S. Cl. CPC H02M 1/15; H02M 1/0003; H02M 1/007; H02M 1/0087; H02M 7/2173; H02M 7/2176; H02M 7/219; H02M 7/25

(57) ABSTRACT

Disclosed is a power converter. The power converter includes: a first converter stage (1) configured to receive three alternating input voltages (Va, Vb, Vc) at input nodes (11a, 11b, 11c) and provide a pulsating output voltage (V1) at an output (12, 13); a second converter stage (2) configured to receive an input voltage (V2) at an input (22, 23) and provide an output voltage (Vo) at an output (24, 25); and a link circuit (3) comprising a link (31, 32) coupled between the output (12, 13) of the first converter stage (1) and the input (22, 23) of the second converter stage (2), and supply nodes (33, 34) coupled to the second converter stage (2). The link circuit (3) is configured to regulate the output current (11) of the first converter stage (1) and regulate an output voltage (Vo) at the output of the second converter stage (2).

This disclosure relates in general to a power converter, in particular, an AC-DC power converter.

An AC-DC power converter may be configured to receive three alternating input voltages and input currents from a three-phase power grid and provide a direct output voltage and a direct output current. In the rapidly evolving landscape of artificial intelligence (AI), the demand for computational power has surged. This increasing need for computational resources has led to a corresponding rise in energy consumption, which results in the need for efficient AC-DC power converters capable of supplying data centers.

Usually, an AC-DC power converter includes two converter stages, a first stage, which may also be referred to as front-end (FE) stage, and a second stage, which may also be referred to as back-end (BE) stage. The first stage is configured to receive alternating input voltages from a three-phase power grid and provide a regulated DC link voltage based on the input voltages. The second stage is configured to generate a regulated direct output voltage based on the DC link voltage. Usually, each of the two converter stages includes a switched-mode power converter, such as, for example, a PFC (Power Factor Correction) converter in the first stage and an LLC converter or a DAB (Dual Active Bridge) converter in the second stage. Operation of each of the two switched-mode power converters is associated with switching losses.

There is a need for an AC-DC power converter with reduced switching losses and thus increased efficiency.

One example relates to a power converter. The power converter includes a first converter stage configured to receive three alternating input voltages at input nodes and provide a pulsating output voltage at an output, a second converter stage configured to receive an input voltage at an input and provide an output voltage at an output, and a link circuit. The link circuit includes a link coupled between the output of the first converter stage and the input of the second converter stage, and supply nodes coupled to the second converter stage. The link circuit is configured to regulate the output current of the first converter stage and regulate an output voltage at the output of the second converter stage.

Another example relates to a method. The method includes regulating an output current of a first converter stage and regulating an output voltage at the output of a second converter stage by a link circuit in a power converter, wherein the power converter includes a first converter stage configured to receive three alternating input voltages at input nodes and provide a pulsating output voltage at an output; a second converter stage configured to receive an input voltage at an input and provide an output voltage at an output; and a link circuit comprising a link coupled between the output of the first converter stage and the input of the second converter stage, and supply nodes coupled to the second converter stage.

Further examples are explained below with reference to the drawings. The drawings serve to illustrate certain principles, so that only aspects necessary for understanding these principles are illustrated. The drawings are not to scale. In the drawings the same reference characters denote like features.

FIG. 1 illustrates one example of a power converter that includes a first converter stage, a second converter stage, and a link circuit;

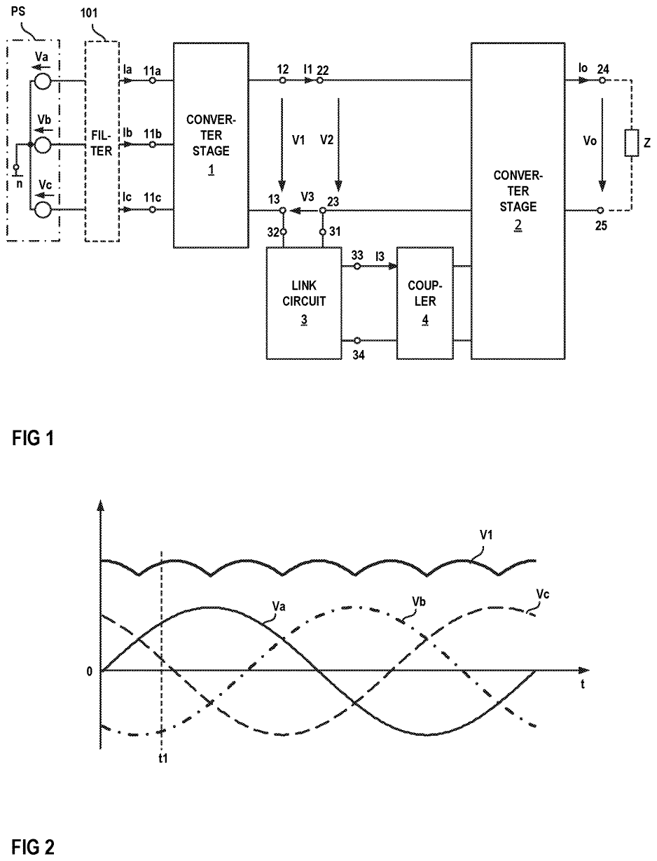

FIG. 2 shows signal diagrams of input voltages and an output voltage of the first converter stage according to one example;

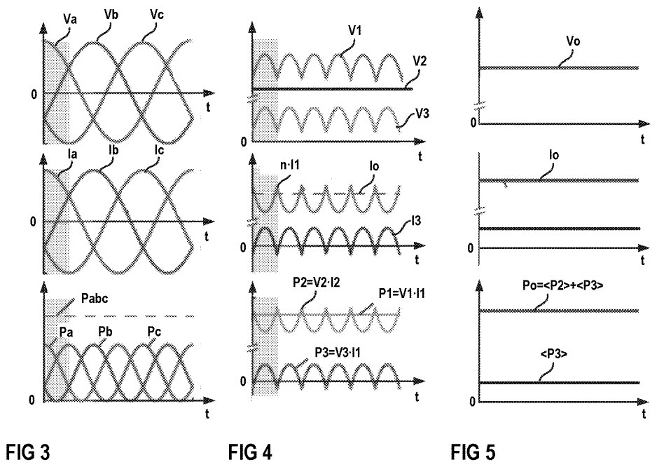

FIGS. 3-6 show signal diagrams that illustrate one example for operating the power converter;

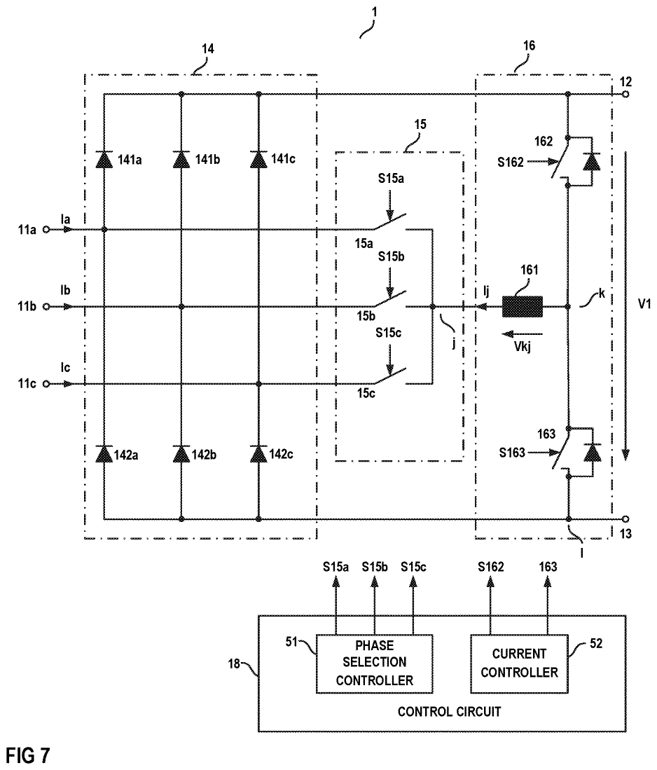

FIG. 7 illustrates one example of the first converter stage;

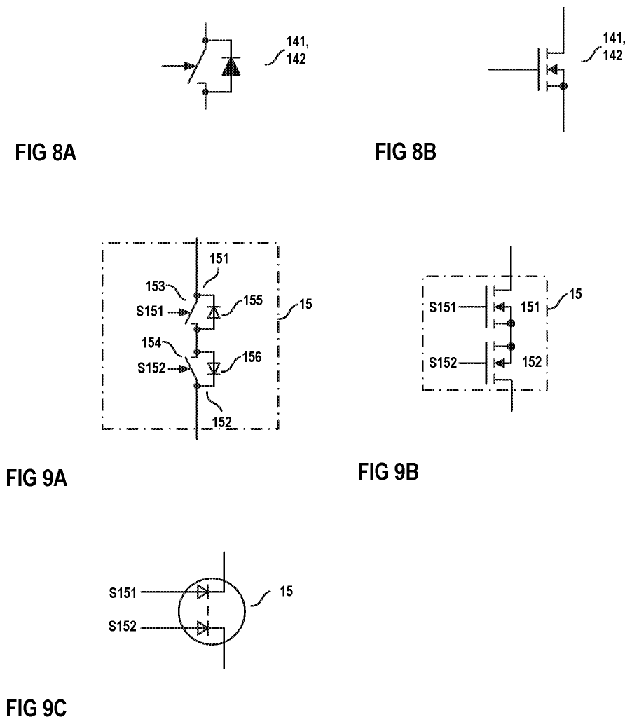

FIGS. 8A-8B illustrate examples for implementing rectifier elements included in the first converter stage according to FIG. 7;

FIGS. 9A-9C illustrate examples for implementing bidirectionally blocking switches included in the first converter stage according to FIG. 7;

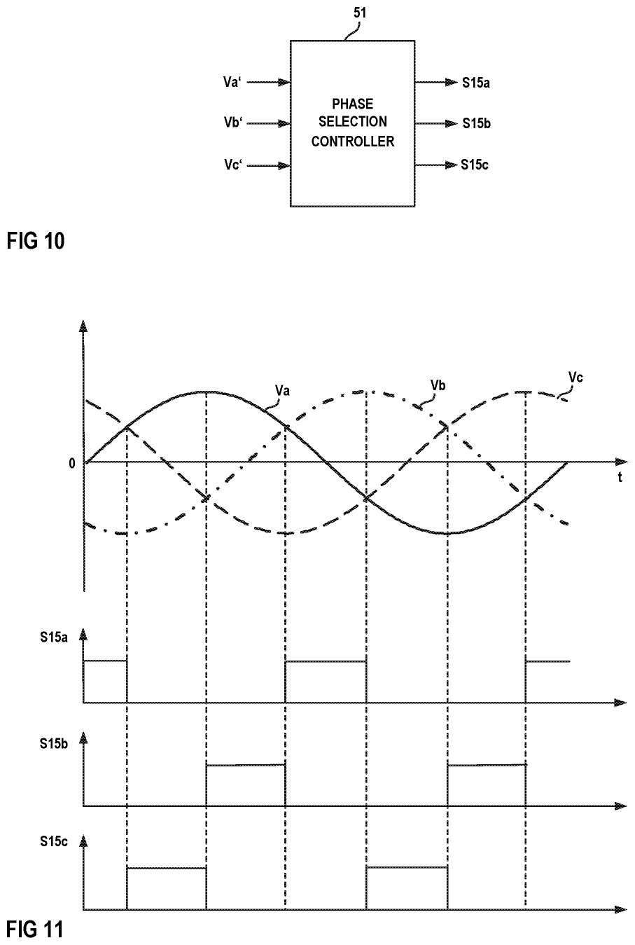

FIG. 10 shows a block diagram of a phase selection controller included in a control circuit of the first converter stage according to FIG. 7;

FIG. 11 shows signal diagrams that illustrate the functionality of the phase selection controller according to FIG. 10;

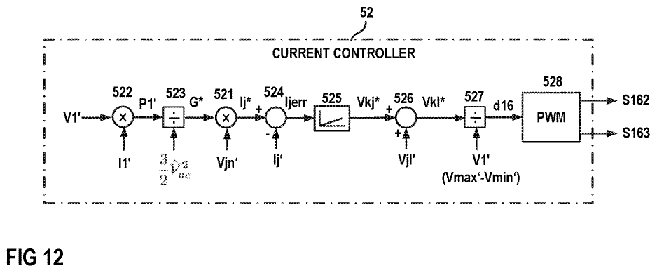

FIG. 12 shows a block diagram of a current controller included in the control circuit of the first converter stage according to FIG. 7;

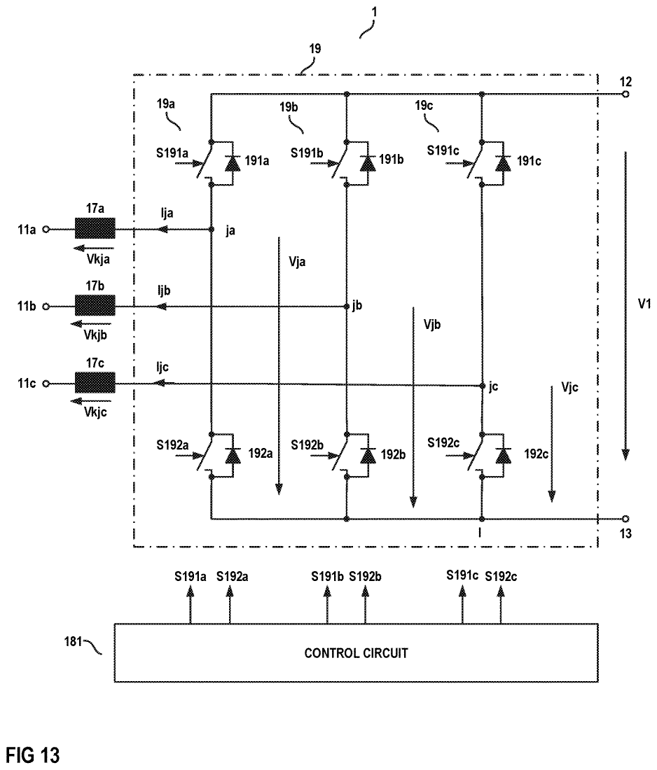

FIG. 13 illustrates a first converter stage according to another example;

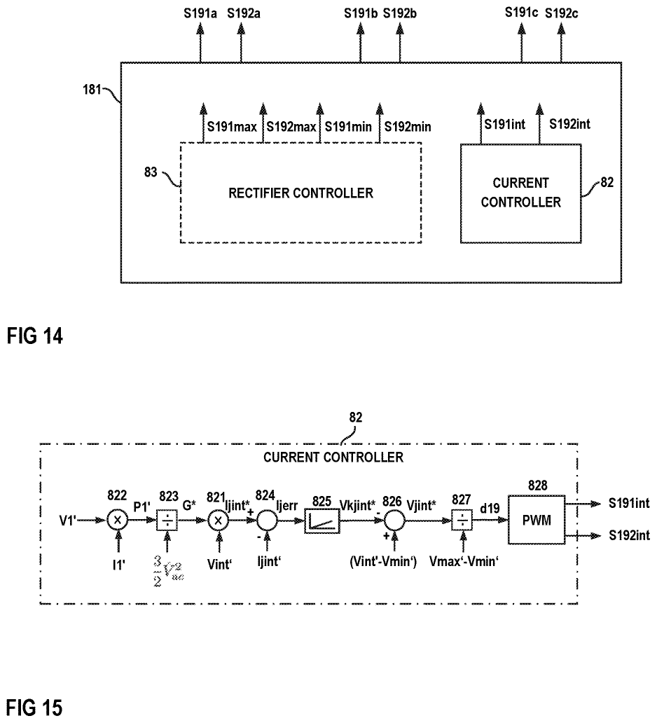

FIG. 14 shows a block diagram of a control circuit of the first converter stage according to FIG. 13;

FIG. 15 shows a block diagram of a current controller included in the control circuit according to FIG. 14;

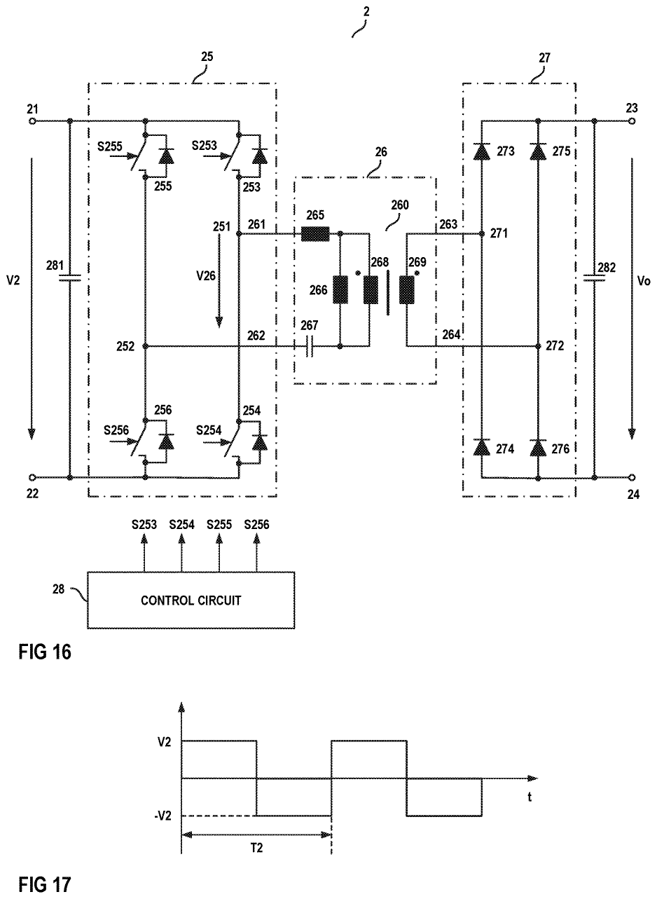

FIG. 16 illustrates one example of the second converter stage;

FIG. 17 shows a signal diagram that illustrates the operating principle of a switching circuit included in the second converter stage according to FIG. 16;

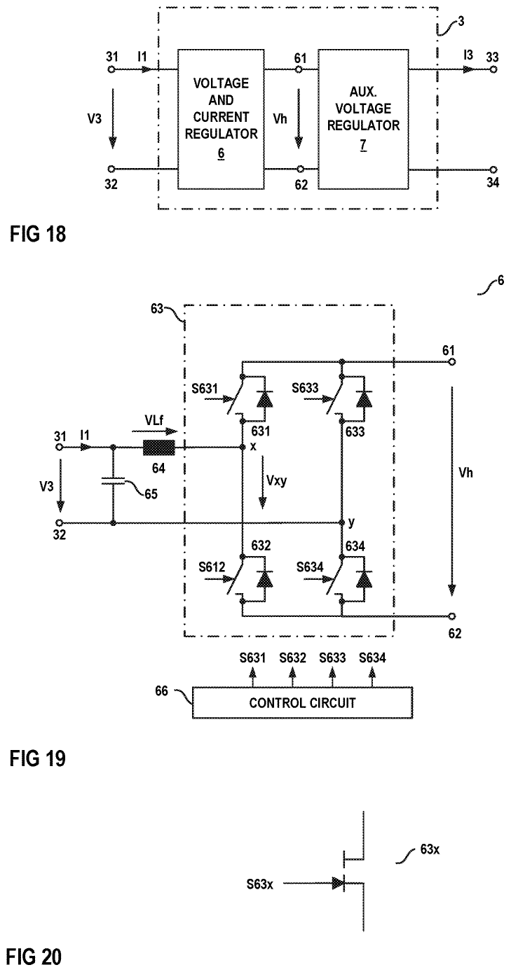

FIG. 18 illustrates one example of a link circuit that includes a voltage and current regulator and a and auxiliary voltage regulator;

FIG. 19 illustrates one example of the voltage and current regulator according to FIG. 18;

FIG. 20 illustrates one example for implementing electronic switches included in the voltage and current regulator according to FIG. 19;

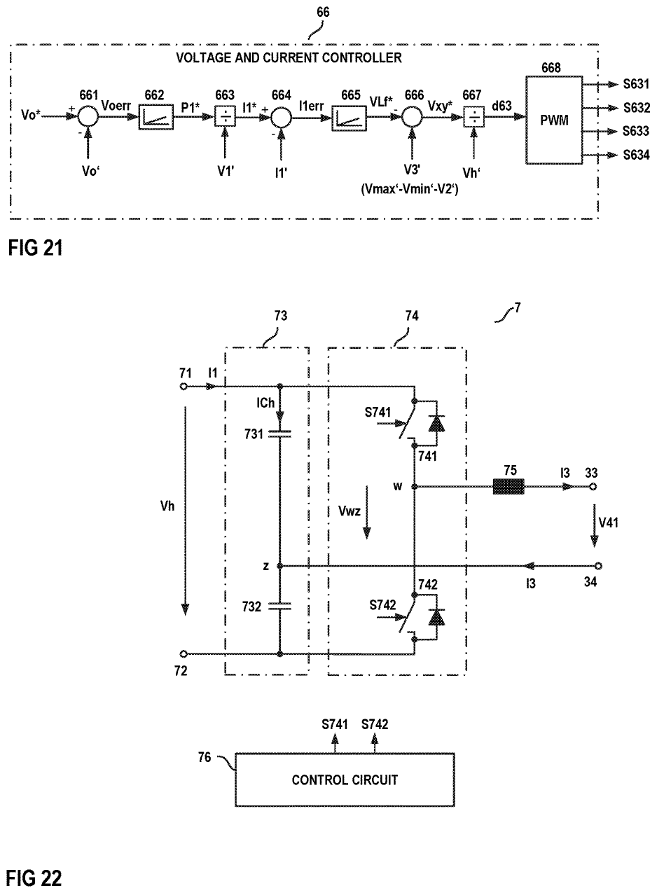

FIG. 21 illustrates one example of a control circuit for controlling operation of the voltage and current regulator according to FIG. 19;

FIG. 22 illustrates one example of the auxiliary voltage regulator;

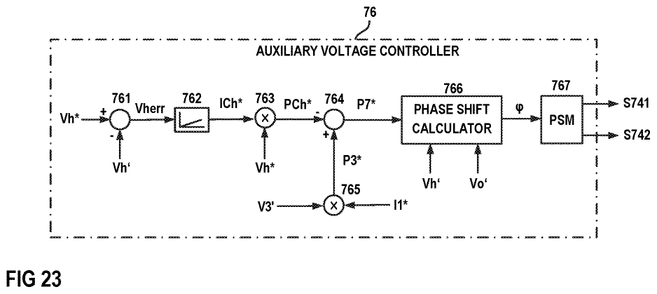

FIG. 23 illustrates one example of a control circuit for controlling operation of the auxiliary voltage regulator according to FIG. 22;

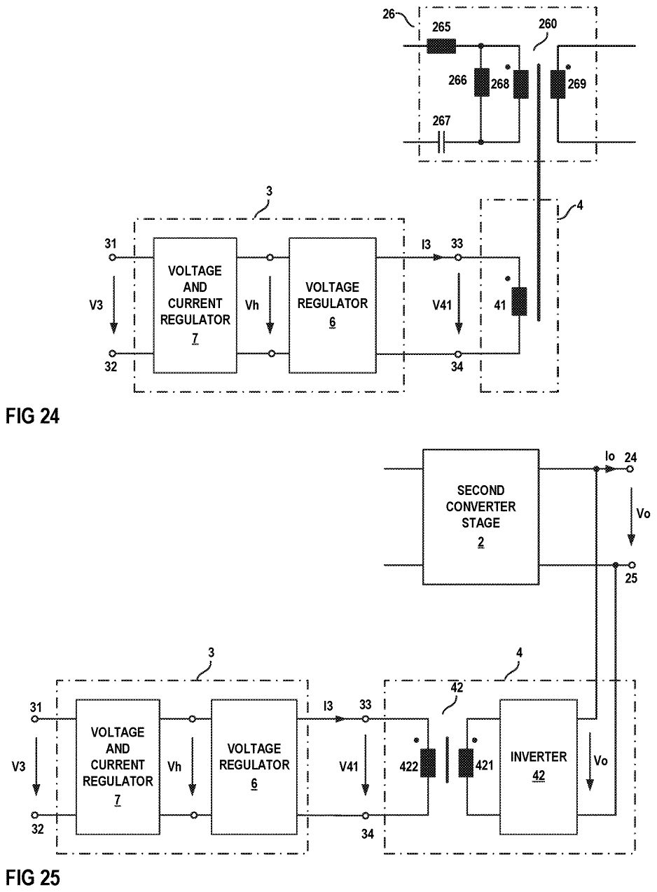

FIG. 24 illustrates one example for coupling the link circuit to the second converter stage;

FIG. 25 illustrates another example for coupling the link circuit to the second converter stage;

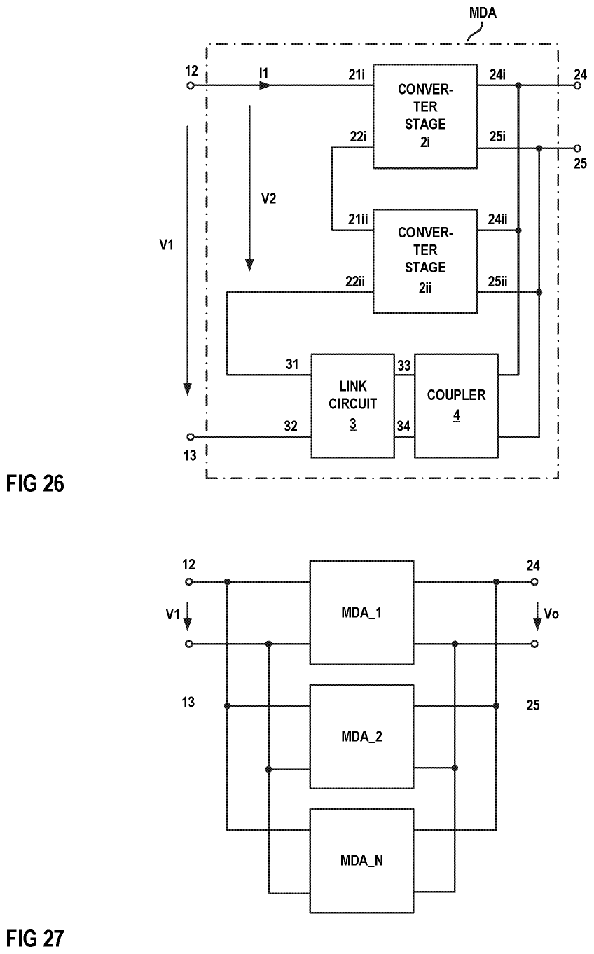

FIG. 26 illustrates one example of a power converter that includes a module with two second converter stages with serially connected inputs and parallel connected outputs and a link circuit;

FIG. 27 illustrates one example of a power converter that includes several modules of the type according to FIG. 26 connected in parallel;

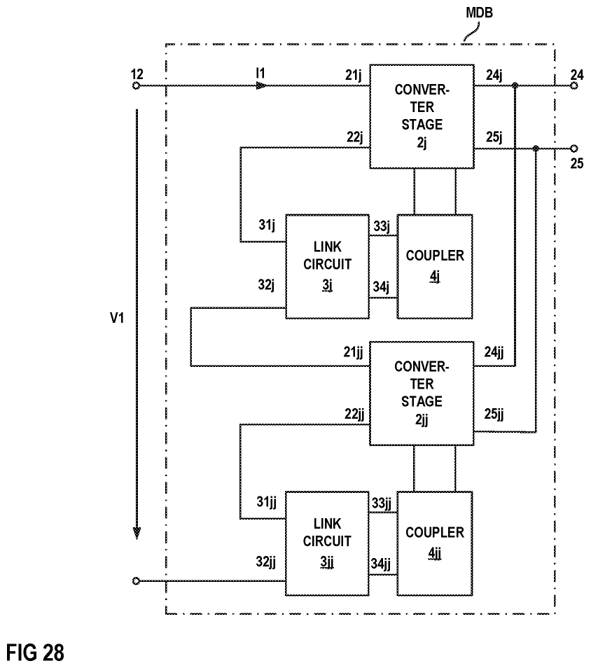

FIG. 28 illustrates one example of a power converter that includes a module with two second converter stages with serially connected inputs and parallel connected outputs and two link circuits with inputs connected in series with the inputs of the second converter stages; and

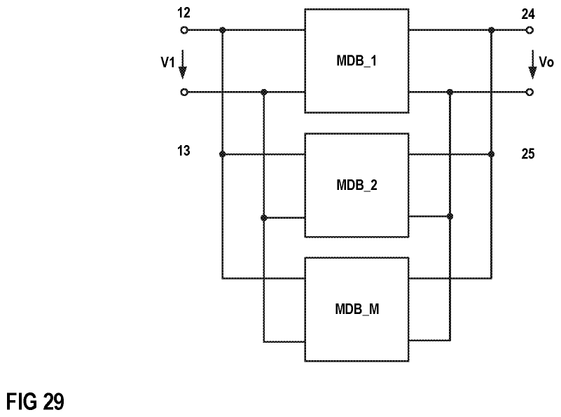

FIG. 29 illustrates one example of a power converter that includes several modules of the type according to FIG. 28 connected in parallel.

In the following detailed description, reference is made to the accompanying drawings. The drawings form a part of the description and for the purpose of illustration show examples of how the invention may be used and implemented. It is to be understood that the features of the various embodiments described herein may be combined with each other, unless specifically noted otherwise.

FIG. 1 illustrates a power converter according to one example. More specifically, FIG. 1 illustrates an AC-DC (alternating current-direct current) power converter according to one example.

Referring to FIG. 1, the power converter includes a first converter stage 1, a second converter stage 2, and a link circuit 3. The first converter stage 1 is configured to receive three alternating input voltages Va, Vb, Vc at an input 11a, 11b, 11c and provide a pulsating output voltage V1 and an output current I1 at an output 12, 13. The second converter stage 2 is configured to receive an input voltage V2 at an input 22, 23 and provide an output voltage Vo at an output 24, 25. The link circuit 3 includes a link 31, 32 coupled between the output 12, 13 of the first converter stage 1 and the input 22, 23 of the second converter stage 2. Furthermore, the link circuit 3 includes supply nodes 33, 34 coupled to the second converter stage 2. The link circuit is configured to regulate the output current of the first converter stage and regulate the output voltage Vo at the output 23, 24 of the second converter stage 2.

The supply nodes 33, 34 of the link circuit are different from the link nodes and are coupled to circuit nodes of the second converter stage 2 different from the input nodes 22, 23. “The link circuit number 3 coupled to the second converter stage 2” may include that the link circuit 3 is coupled to internal circuit nodes of the converter stage 2 different from the input nodes 22, 23, or may include that the link circuit 3 is coupled to the output 24, 25 of the second converter stage 2.

The input voltages Va, Vb, Vc of the first converter stage 1 may also be referred to as input voltages of the power converter, and input currents Ia, Ib, Ic received by the first converter stage 1 at the input 11a, 11b, 11c may also be referred to as input currents of the power converter. Furthermore, the output voltage Vo of the second converter stage 2 may also be referred to as output voltage Vo of the power converter, and an output current Io provided by the second converter stage at its output 24, 24 may also be referred to as output current Io of the power converter.

Referring to the above, the link circuit 3 is configured to regulate the output current of the first converter stage. By regulating the output current I1 of the first converter stage 1, is configured to (a) regulate a power Po output by the second converter stage 2 at the output 24, 25, and thereby regulate the output voltage Vo of the second converter stage 2, and (b) to operate the first converter stage 1 in a PFC (Power Factor Correction) mode. This functionality is explained in detail herein further below.

The power Po output by the second converter stage 2 is given by the output voltage Vo multiplied with the output current Io. The output 24, 25 is configured to have a load Z (illustrated in dashed lines) with varying power consumption connected thereto.

Referring to FIG. 1, the input of the first converter stage 1 includes three input nodes 11a, 11b, 11c. The first converter stage 1 is configured to receive a respective one of the three input voltages Va, Vb, Vc at each of the three input nodes 11a, 11b, 11c. According to one example, the input voltages Va, Vb, Vc are provided by a power source PS, such as a three-phase power grid, and are referenced to a reference node n, such as a ground node.

Optionally, an input filter 101 (illustrated in dashed lines) is connected between the power source PS and the input 11a, 11b, 11c of the first converter stage 1. Thus, the input voltages received by the converter stage 1 are either supply voltages Va, Vb, Vc directly received from the power source PS, or supply voltages Va, Vb, Vc received from the power source PS through the input filter 101.

The first converter stage 1 is configured to receive a respective input current Ia, Ib, Ic at each of the three input nodes 11a, 11b, 11c. According to one example, the optional input filter 101 is configured to filter out high-frequency current ripples from the input currents Ia, Ib, Ic, which may result from a switched mode operation of the first converter stage 1. The input filter 101, however, does not affect the general waveforms of input voltages Va, Vb, Vc and the input currents Ia, Ib, Ic, so that the input voltages received at the inputs 11a, 11b, 11c correspond to the supply voltages.

As explained below, the “general waveforms” of the input voltages Va, Vb, Vc are sinusoidal waveforms, for example. Input filters of AC-DC converters are commonly known, so that no further explanation is required in this regard.

Referring to FIG. 1, the output of the first converter stage 1 includes a first output node 12 and a second output node 13. The output voltage V1 of the first converter stage 1 is a voltage between the first output node 12 and the second output node 13. In addition to the output voltage V1, the first converter stage 1 provides the output current I1 which is regulated by the link circuit 3 in a way explained in detail herein further below.

Referring to FIG. 1, the input of the second converter stage 2 includes a first input node 22 and a second input node 23. The input voltage V2 of the second converter stage 2 is a voltage between the first input node 22 and the second input node 23. In addition to the input voltage V2, the second converter stage 2 receives an input current which is equal to the output current I1 of the first converter stage 1. Thus, in the following, I1 denotes both the output current of the first converter stage 1 and the input current of the second converter stage 2.

The supply nodes 33, 34 of the link circuit 3 are coupled to the second converter stage 2 in such a way that a power transfer can take place between the link circuit 3 and the second converter stage 2. That is, the link circuit 3 may receive power from the second converter stage 2 or provide power to the second converter stage 2, whatever is necessary to regulate the output current I1 of the first converter stage 1. Referring to FIG. 1, the supply nodes 33, 34 of the link circuit 3 are coupled to the second converter stage 2 through a coupling circuit 4. There are various ways for coupling the link circuit 3 to the second converter stage 2 and thus for implementing the coupling circuit 4. According to one example, the supply nodes 33, 34 are coupled to internal circuit nodes of the second converter stage 2. According to another example, the supply nodes 33, 34 are coupled to the output nodes 24, 25 of the converter stage 2. More detailed examples for coupling the link circuit 3 to the second converter stage 2 are explained herein further below.

The link 31, 32 of the link circuit 3 being coupled between the output of the first converter stage 1 and the input of the second converter stage 2 includes that the link 31, 32 of the link circuit 3 is connected between one of the output nodes 12, 13 of the first converter stage 1 and one of the input nodes 22, 23 of the second converter stage 2. Just for the purpose of illustration, in the example illustrated in FIG. 1, the link 31, 32 of the link circuit 3 is connected between the second output nodes 13 of the first converter stage 1 and the second input node 23 of the second converter stage 2. More specifically, a first link node 31 of the link is connected to the second input node 23 of the second converter stage 2 and a second link node 32 of the link is connected to the second output node 13 of the first converter stage 1.

A link voltage V3 of the link circuit 3 is a voltage between the first link node 31 and the second link node 32. The input voltage V2 of the second converter stage 2 is directly dependent on the pulsating output voltage V1 of the first converter stage 1 and the link voltage V3 of the link circuit 3 as being the difference between the output voltage V1 of the first converter stage 1 and the link voltage V3,

$$V 2 = V 1 - V 3 . \qquad ( 1 )$$

According to one example, the second converter stage 2 includes an unregulated power converter that is configured to generate the output voltage Vo to be essentially proportional to the input voltage V2,

$$V o = \frac{1}{n} \cdot V 2 , \qquad ( 2 )$$

where 1/n is the proportionality factor between the output voltage Vo and the input voltage V2 of the second converter stage 2.

FIG. 2 shows signal diagrams of three input voltages Va, Vb, Vc according to one example. Referring to the above, the input voltages Va, Vb, Vc are voltages received from a three-phase power grid. In this example, each of the three input voltages Va, Vb, Vc is a sinusoidal input voltage, wherein the input voltages Va, Vb, Vc have the same frequency and RMS value. According to one example, a phase shift between each pair of the input voltages Va, Vb, Vc is 120° (2π/3). Signal diagrams of three sinusoidal input voltages Va, Vb, Vc with a mutual phase shift of 120° are illustrated in FIG. 2 over one period of the input voltages Va, Vb, Vc. The frequency is 50 Hz or 60 Hz, the RMS value is 230 VRMS or 110 VRMS, for example.

At each time (except for short time periods in which two of the input voltages Va, Vb, Vc cross each other) one of the three input voltages Va, Vb, Vc is the highest (or maximum) input voltage Vmax and one of the three input voltages Va, Vb, Vc is the lowest (or minimum) input voltage Vmin. The “highest input voltage” is that one of the three input voltages Va, Vb, Vc that has the highest voltage level and the “lowest input voltage” is that one of the three input voltages Va, Vb, Vc that has the lowest voltage level. The voltage level can be positive or negative, so that the highest input voltage Vmax has the most positive voltage level and the lowest input voltage Vmin has the most negative voltage level. At time instance t1 illustrated in FIG. 2, for example, input voltage Va is the highest input voltage and input voltage Vb is the lowest input voltage. That one of the three input voltages that has a voltage level between the voltage level of highest input voltage Vmax and the voltage level of the lowest input voltage Vmin is referred to as intermediate input voltage Vint in the following. At time instance t1 illustrated in FIG. 2, input voltage Vc is the intermediate input voltage Vint.

According to one example, the first converter stage 1 is configured to generate the pulsating output voltage V1 such that the instantaneous voltage level of the pulsating output voltage V1 equals the difference between the voltage level of the instantaneously highest input voltage Vmax and the voltage level of the instantaneously lowest input voltage Vmin,

$$V 1 = V max - V min . \qquad ( 3 )$$

In this case, the output voltage V1 is a pulsating voltage that includes six pulses over one period of the input voltages Va, Vb, Vc and may therefore be referred to as output voltage V1 with a six-pulse shape or six-pulse waveform. An output voltage V1 with a six-pulse waveform based on three sinusoidal input voltages Va, Vb, Vc can be generated with low losses and thus a high efficiency and using a relatively simple converter stage topology which may mainly consist of passive devices. This is explained in detail herein further below. An output voltage with a six-pulse waveform resulting from a difference between the maximum input voltage Vmax and the minimum input voltage Vmin is also illustrated in FIG. 2.

Referring to the above, the first converter stage 1 is operated in a PFC mode. That is, the first converter stage 1 is operated as a PFC converter. In this case, the input currents Ia, Ib, Ic received at the inputs 11a, 11b, 11c have essentially the same waveforms as the input voltages Va, Vb, Vc, so that, when the input voltages Va, Vb, Vc are sinusoidal input voltages, the input currents Ia, Ib, Ic each have a sinusoidal waveform with the same frequency as the input voltages Va, Vb, Vc. The input currents Ia, Ib, Ic may be generated to be in phase with the input voltages Va, Vb, Vc. Alternatively, the input currents Ia, Ib, Ic may be generated such that there is a (slight) phase shift between the input currents Ia, Ib, Ic and the input voltages Va, Vb, Vc. Signal waveforms that illustrate operating the first converter stage 1 as a PFC converter are illustrated in FIG. 3 and explained below.

Referring to the above and as explained in detail below, “the first converter stage 1 being operated in a PFC mode (as a PFC converter)” includes regulating the output current I1 of the first converter stage 1 by the link circuit 3.

FIG. 3 shows signal diagrams of the input voltages Va, Vb, Vc, the input currents Ia, Ib, Ic, and the input powers Pa, Pb, Pc received at the individual input nodes 11a, 11b, 11c and the overall input power Pabc (=Pa+Pb+Pc) received by the first converter stage 1. The input power Pa, Pb, Pc received at each input node 11a, 11b, 11c is given by the respective input voltage Va, Vb, Vc multiplied with the respective input current Ia, Ib, Ic. As can be seen from FIG. 3, if the three input voltages Va, Vb, Vc have the same amplitude and the three input currents Ia, Ib, Ic have the same amplitude and the same (sinusoidal) waveform as the input voltages Va, Vb, Vc, the overall input power Pabc is essentially constant. The input currents Ia, Ib, Ic are in phase with the input voltages Va, Vb, Vc in this example.

FIG. 4 shows signal diagrams that illustrate operation of the link circuit 3. More specifically, FIG. 4 shows, in a first diagram, signal waveforms of the pulsating output voltage V1 of the first converter stage 1, the link voltage V3 of the link circuit 3 and the resulting input voltage V2 of the second converter stage 2; in a second diagram, the output current I1 of the first converter stage 1, the output current Io of the second converter stage 2, and a supply current 13 received at the supply nodes 33, 34 of the link circuit 3; and, in a third diagram, an output power P1 provided at the output 12, 13 of the first converter stage 1, an input power P2 received at the input 22, 23 of the second converter stage 2, and an input power P3 received at the link nodes 31, 32 of the link circuit 3, which may also be referred to as link power P3. The link power P3 of the link circuit 3 can be positive or negative. When the link power P3 of the link circuit 3 is positive, the link circuit 3 receives a portion of the output power P1 of the first converter stage 1, thereby reducing the input power P2 of the second converter stage 2. When the link power P3 of the link circuit 3 is negative, the link circuit 3 provides power to the second converter stage 2, thereby increasing the input power P2 of the second converter stage 2. The latter may include providing power to the output 23, 24 of the second converter stage 2. In both cases, positive or negative link power P3, the output current I1 of the first converter stage 1 has the same direction (polarity), but the polarity of the link voltage V3 is different.

In order to make it easier to compare the output current I1 of the first converter stage 1 (the input current of the second converter stage 2) with the output current Io of the second converter stage 2, FIG. 4 shows n times the output current I1, where n, referring to equation (2), is the reciprocal of the proportionality factor between the output voltage Vo and the input voltage V2 of the second converter stage 2. Furthermore, it should be noted that I3 as illustrated in FIG. 4 is not to scale.

The output power P1 of the first converter stage 1 is given by the output voltage V1 multiplied with the output current I1. The input power P2 of the second converter stage 2 is given by the input voltage V2 multiplied with the input current I1. The link power P3 of the link circuit 3 is given by the link voltage V3 multiplied with the output current I1 of the first converter stage 1 because, due to the link circuit 3 being connected in series with the input of the second converter stage 2, the output current I1 of the first converter stage 1 also flows at the link nodes 31, 32 of the link circuit 3.

As can be seen from FIG. 4, the link voltage V3 has a six-pulse waveform that is in correspondence with the six-pulse waveform of the pulsating output voltage V1 of the first converter stage 1, so that in accordance with equation (1) the input voltage V2 of the second converter stage 2 is essentially constant.

Given the proportionality between the input voltage V2 of the second converter stage 2 and its output voltage Vo the output voltage Vo of the second converter stage 2 is essentially constant. This is illustrated in FIG. 5.

Referring to FIG. 4, the link circuit 3 is configured to regulate the waveform of the output current I1 of the first converter stage 1 such that the output current I1 has an inverted six-pulse waveform. This is to achieve that the output power P1 of the first converter stage 1, which essentially equals the input power Pabc of the first converter stage 1, is essentially constant and is in correspondence with

$$I 1 = \frac{P a b c}{V 1} . \qquad ( 4 )$$

Furthermore, as explained in detail herein further below, this is to achieve the PFC functionality of the first converter stage 1.

Referring to FIG. 4, the input power P2 of the second converter stage 2 has an inverted six-pulse waveform, which is due to the fact that the input voltage V2 of the second converter stage 2 is essentially constant and the input current I1 of the second converter stage 2 has the inverted six-pulse waveform for achieving a constant output power P1 of the first converter stage 1. According to one example, the second converter stage 2 includes an input capacitor (such as capacitor 281 illustrated in FIG. 16 and explained below) that compensates for (or buffers) such pulsations of the input power P2 and provides for an essentially constant output power Po.

The overall output power Po of the second converter stage 2 is given by the average <P2> of the input power P2 of the second converter stage 2 plus the average <P3> of the input power P3 of the link circuit.

As can be seen from the signal diagrams in FIG. 4, the link circuit 3 is capable of compensating the six-pulse waveform of the output voltage V1 of the first converter stage 1 so that the input voltage V2 received by the second converter stage 2 is essentially constant. Referring to the above, the link circuit 3 is coupled to the second converter stage 2 via its supply nodes 33, 34, so that a power transfer can take place between the link circuit 3 and the second converter stage 2. Due to this coupling of the link circuit 3 to the second converter stage 2, the link circuit 3 is further capable of compensating for variations of the RMS values of the input voltages Va, Vb, Vc. Thus, the input voltage V2 of the second converter stage 2 and its output voltage Vo are essentially constant despite possible variations of the RMS values of the input voltages Va, Vb, Vc.

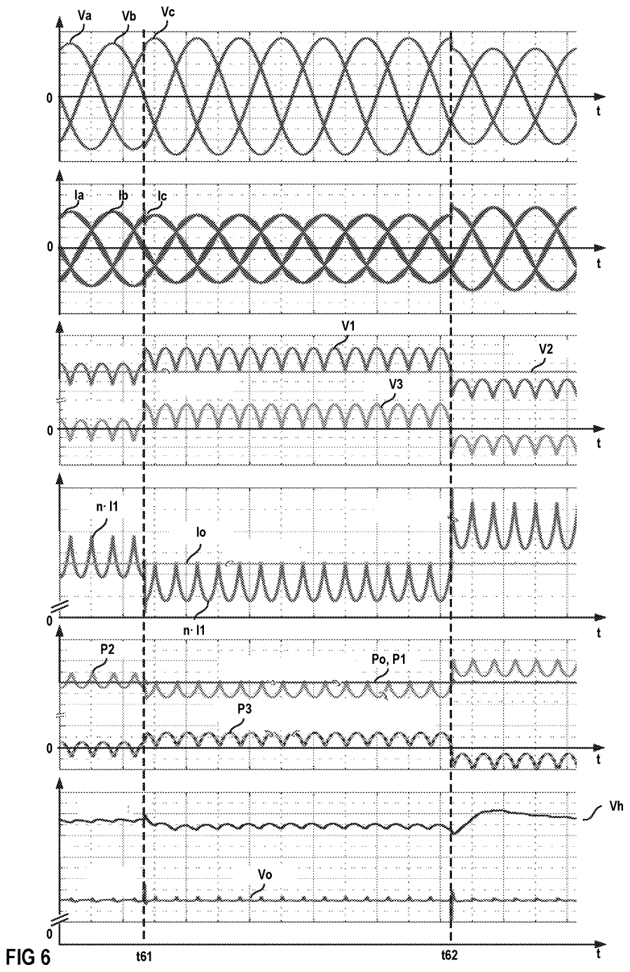

The capability of the link circuit 3 to regulate the output current I1 of the first converter stage 1 such that the output voltage Vo is essentially constant, despite variations of the RMS values of the input voltages Va, Vb, Vc, is illustrated in FIG. 6.

FIG. 6 shows, in a first diagram, signal waveforms of three sinusoidal input voltages Va, Vb, Vc; in a second diagram, signal waveforms of the corresponding sinusoidal input currents Ia, Ib, Ic; in a third diagram, signal waveforms of the pulsating output voltage V1 of the first converter stage 1, the input voltage V2 of the second converter stage 2, and the pulsating link voltage V3 of the link circuit 3; in a fourth diagram n times the output current I1 of the first converter stage 1 and the output current Io of the second converter stage 2; in a fifth diagram the input power P2 and the output power Po of the second converter stage 2, and the input power P3 of the link circuit 3; and, in a sixth diagram, the output voltage Vo.

Furthermore, FIG. 6 shows a regulated auxiliary voltage Vh that is generated in the link circuit 3 and used by the link circuit 2 to regulate the output current I1 of the first converter stage 1. As can be seen, the auxiliary voltage Vh is subject to slight fluctuations in accordance with the frequency of the input voltages Va, Vb, Vc. Furthermore, the auxiliary Vh may deviate from a desired (average) voltage level for a certain time period when the RMS value of the input voltages Va, Vb, Vc changes, but is regulated to the desired (average) voltage level over the time. Such fluctuations and variations are less than 5% or even less than 2% of the average voltage level of the auxiliary voltage Vh, for example.

In the example illustrated in FIG. 6, the input voltages Va, Vb, Vc have an initial RMS value, which is associated with an initial amplitude. At a first time instance t61 the RMS value of the input voltages Va, Vb, Vc increases to a value higher than the initial value, which is associated with an amplitude of the input voltages Va, Vb, Vc being higher than the initial amplitude. The increased amplitudes of the input voltages Va, Vb, Vc result in an increased output voltage V1 of the first converter stage 1. In particular, a DC component of the pulsating output voltage V1 of the first converter stage 1 increases.

As can be seen from FIG. 6, after the first time instance t61, the link circuit 3 reduces the output current I1 of the first converter stage 1 in order to maintain the output power P1 of the first converter stage 1 at a desired power level and thus to maintain the output power Po and the output voltage Vo of the second converter stage 2 at the desired power level. More specifically, the link circuit 3 regulates the output current I1 of the first converter stage 1 to reduce a DC component of the output current I1. The inverted six-pulse waveform of the output current I1 is maintained.

Furthermore, after the first time instance t61, the link voltage V3 increases. More specifically, a DC component of the link voltage V3 increases, which compensates for the increased DC component of the output voltage V1 of the first converter stage 1 and maintains the input voltage V2 of the second converter stage 2 and the output voltage Vo at a respective desired voltage level. The increased link voltage V3 is associated with an increased input power P3 of the link circuit 3.

In the example illustrated in FIG. 6, at a second time instance t62 after the first time instance t61, the RMS value of the input voltages Va, Vb, Vc decreases to a value lower than the initial value. This reduced RMS value is associated with an amplitude of the input voltages Va, Vb, Vc being lower than the initial value. The reduced amplitude of the input voltages Va, Vb, Vc results in a reduced output voltage V1 of the first converter stage 1. More specifically, a DC component of the pulsating output voltage V1 of the first converter stage 1 is reduced.

As can be seen from FIG. 6, after the second time instance t62, the link circuit 3 increases the output current I1 of the first converter stage 1 in order to maintain the output power P1 of the first converter stage 1 at a desired power level and thus to maintain the output power Po of the second converter stage 2 at the desired power level. More specifically, the link circuit 3 increases a DC component of the output current I1. The inverted six-pulse waveform is maintained.

Furthermore, after the second time instance t62, the link voltage V3 decreases. More specifically, a DC component of the link voltage V3 decreases to compensate for the decreased DC component of the output voltage V1 of the first converter stage 1 and maintain the input voltage V2 and the output voltage Vo of the second converter stage 2 at the respective desired voltage level. The decreased link voltage V3 is associated with a decreased link power P3 of the link circuit 3.

In the example illustrated in FIG. 6, the link power P3 of the link circuit 3 is positive at each time between the first and second time instance t61, t62, which is equivalent to the link circuit 3 receiving power. This includes that a DC component of the input power P3 and an average (over one half-period of the input voltages Va, Vb, Vc) is positive.

Furthermore, the link power of the link circuit P3 is negative at each time after the second time instance t62, which is equivalent to the link circuit 3 providing power to the input of the second converter stage 2. This includes that a DC component of the input power P3 and an average (over one half-period of the input voltages Va, Vb, Vc) is negative.

Furthermore, before the first time instance t61, the input power P3 of the link circuit 3 varies between positive and negative power levels, so that there are time periods in which the link circuit 3 receives power from the first converter stage 1 and other time periods in which the link circuit 3 provides power to the second converter stage 2.

The capability of the link circuit 3 to either receive power from the output 12, 13 of the first converter stage 1 or provide power to the input of the second converter stage 2 makes it possible to compensate for variations of the RMS value of the input voltages Va, Vb, Vc, thereby maintaining the output voltage Vo at a predefined voltage level. This is illustrated in FIG. 6 from which it can be seen that the output voltage Vo, which is proportional to the input voltage V2 of the second converter stage 2, is kept essentially constant except for short voltage spikes at the first and second time instances t61, t62.

FIG. 7 illustrates one example of the first converter stage 1. In this example, the first converter stage 1 is implemented as IAF (Integrated Active Filter) rectifier that includes a rectifier bridge 14, a phase selection circuit 15, and a current control circuit 16.

Referring to FIG. 7, the rectifier bridge 14 includes three rectifier half-bridges each coupling a respective one of the three input nodes 11a, 11b, 11c to each of the first and second output nodes 12, 13. More specifically, each of the three rectifier half-bridges includes a first rectifier element 141a, 141b, 141c connected between the respective input node 11a, 11b, 11c and the first output node 12, and a second rectifier element 142a, 142b, 142c connected between the respective input node 11a, 11b, 11c and the second output nodes 13.

Each of the first rectifier elements 141a, 141b, 141c is implemented such that it conducts whenever the electrical potential at the respective first input node 11a, 11b, 11c becomes higher than the electrical potential at the first output node 12. This can be achieved by implementing the first rectifier elements 141a, 141b, 141c as diodes and connecting cathode nodes of the diodes to the first output node 12. Equivalently, each of the second rectifier elements 142a, 142b, 142c is implemented such that it conducts whenever the electrical potential at the respective first input node 11a, 11b, 11c becomes lower than the electrical potential at the second output node 13. This can be achieved by implementing the second rectifier elements 142a, 142b, 142c as diodes and connecting anode nodes of the diodes to the second output node 13.

The rectifier bridge 14 with the three rectifier half-bridges automatically adjusts the output voltage V1 of the first converter stage 1 to be essentially equal to the difference between the instantaneously maximum input voltage Vmax and the instantaneously minimum input voltage Vmin.

It should be noted that implementing the rectifier elements 141a, 141b, 141c, 142a, 142b, 142c as passive rectifier elements, such as diodes, is only an example. Referring to FIG. 8A, it is also possible to implement the first and second rectifier elements 141a, 141b, 141c, 142a, 142b, 142c as synchronous rectifier elements. A synchronous rectifier element includes an electronic switch and a passive rectifier element, such as a diode, connected in parallel with the electronic switch. The topology of a synchronous rectifier element is the topology of a unidirectionally blocking electronic switch. As compared to a pure passive rectifier element, a synchronous rectifier element offers reduced conduction losses. Furthermore, a first converter stage 1 implemented with synchronous rectifier elements may provide for a bidirectional power flow which, however, is not needed in the context disclosed herein. The electronic switches included in the synchronous rectifier elements can be implemented as low-frequency switches, as each synchronous rectifier element needs to switch on and off only once during each period of the input voltages Va, Vb, Vc.

According to one example illustrated in FIG. 8B, the synchronous rectifier element is a MOSFET, such as an N-type enhancement MOSFET, with an integrated body diode (not illustrated) that forms the passive rectifier element of the synchronous rectifier element. In FIGS. 8A and 8B, reference number 141 represents an arbitrary one of the first rectifier elements 141a, 141b, 141c, and reference number 142 represents an arbitrary one of the second rectifier elements 142a, 142b, 142c.

Referring to FIG. 7, the phase selection circuit 15 includes three electronic switches 15a, 15b, 15c each connected between a respective one of the input nodes 11a, 11b, 11c and a first circuit node j. Each of the three switches 15a, 15b, 15c switches on or off dependent on a respective drive signal S15a, S15b, S15c provided by a phase selection controller 51 in a control circuit 18. The control circuit 18 is configured to control operation of the first converter stage 1.

According to one example, the electronic switches 15a, 15b, 15c, which are only schematically illustrated in FIG. 7, are implemented as bidirectionally blocking electronic switches. A “bidirectionally blocking electronic switch” is an electronic switch that, in the off-state, is configured to block independent of a polarity of a voltage applied across the electronic switch. A bidirectionally blocking electronic switch may be implemented in various ways. Examples are explained with reference to FIGS. 9A-9C in the following. In these figures, reference number 15 denotes an arbitrary one of the electronic switches 15a, 15b, 15c in the first converter stage 1.

According to FIG. 9A, the bidirectionally blocking switch 15 may include two unidirectionally blocking electronic switches 151, 152 connected in series. These unidirectionally blocking electronic switches 151, 152 may be referred to as partial switches. A “unidirectionally blocking electronic switch” is an electronic switch that, in the off-state, is configured to block when a voltage applied across the switch has a first polarity and to conduct when the voltage has a second polarity opposite the first polarity. A unidirectionally blocking electronic switch can be considered to include a switching element 153, 154 and a freewheeling element 155, 156, such as a diode, connected in parallel with the switching element 153, 154, wherein the freewheeling elements 155, 156 are connected in anti-series.

The unidirectionally blocking electronic switches 151, 152 may be implemented in various ways. Basically, any type of electronic switching element and any type of rectifier element connected in parallel with the switching element may be used to implement one unidirectionally blocking electronic switch.

A MOSFET, for example, is a unidirectionally blocking electronic switch. Thus, as illustrated in FIG. 9B, the bidirectionally blocking electronic switch 15 may include two MOSFETs (Metal Oxide Semiconductor Field-Effect Transistors) that are connected in series such that internal body diodes of the MOSFETs are connected in anti-series. The body diode of a MOSFET acts as a freewheeling element and makes the MOSFET a unidirectionally blocking electronic switch.

According to another example illustrated in FIG. 9C, the bidirectionally blocking electronic switch 15 is a bidirectionally blocking gallium nitride (GaN) switch. Such bidirectionally blocking GaN switch includes two GaN HEMTs (High Electron-Mobility Transistors) as partial switches that are connected in series in such a way that internal freewheeling elements are connected in anti-series. According to one example, the two GaN HEMTs are two single GaN HEMTs connected in series. According to another example, the two GaN HEMTs are monolithically integrated and each have a control node but share the same active area. Thus, a monolithic bidirectionally blocking GaN HEMT has the benefit of using the same active area (instead of two different active areas in the case of two single GaN HEMT is connected in series), which results in a reduced on-resistance, which is the electrical resistance in the on-state.

In each case, the bidirectionally blocking electronic switch 15 is configured to receive two drive signals S151, S152. That is, the bidirectionally blocking electronic switch is configured to receive a respective drive signal S151, S152 for each of the two partial switches. The bidirectionally blocking switch is in the off-state when each of the partial switches is in the off-state and is in the on-state when each of the partial switches is in the on-state. In the off-state, the bidirectionally blocking switch 15 blocks independent of the polarity of the voltage applied across the switch 15. In the on-state, the bidirectionally blocking switch conducts independent of the polarity of the voltage applied across the switch.

According to one example, the first and second partial switches 151, 152 are essentially driven synchronously. That is, the two drive signals S151, S152 are essentially the same and correspond to one of the respective drive signals S15a, S15b, S15c illustrated in FIG. 7. “Essentially” includes that during switch-over between the on-state and the off-state of the bidirectionally blocking switch 15 there may be a short time period in which one of the partial switches 151, 152 is already blocking while the other one of the partial switches is still conducting 151, 152. This is basically known in the operation of a bidirectionally blocking switch, so that no further explanation is required in this regard.

The phase selection controller 51 is configured to switch on only one of the three switches 15a, 15b, 15c at each time. More specifically, the phase selector 15 is configured to switch on that one of the three switches 15a, 15b, 15c that is connected to that one of the three input nodes 11a, 11b, 11c that instantaneously receives the intermediate voltage Vint. Referring to the above, the intermediate voltage Vint is that one of the three input voltages Va, Vb, Vc which has a voltage level that is between the voltage level of the highest input voltage Vmax and the lowest input voltage Vmin. Switching on that one of the three switches 15a, 15b, 15c that receives the intermediate voltage Vint does not affect generating the output voltage V1 to be equal to the difference between the maximum input voltage Vmax and the minimum input voltage Vmin. That one of the three input nodes 11a, 11b, 11c that receives the maximum input voltage Vmax is coupled to the first output node 12 through respective first rectifier element 141a, 141b, 141c, and that one of the three input nodes 11a, 11b, 11c that receives the minimum input voltage Vmin is coupled to the second output nodes 13 through the respective second rectifier element 142a, 142b, 142c.

As can be seen from FIG. 2, in each period of the input voltages Va, Vb, Vc, each of the input voltages Va, Vb, Vc is the intermediate voltage during two respective time periods. Thus, each of the switches 15a, 15b, 15c needs to switch on and off only two times during each period of the input voltages Va, Vb, Vc. The electronic switches 15a, 15b, 15c can thus be implemented as low-frequency bidirectionally blocking electronic switches.

Referring to FIG. 7, the current control circuit includes an inductor 161 connected between the first circuit node j and a second circuit node k. The second circuit node k is the switched node of a half-bridge with a first electronic switch 162 connected between the second circuit node k and the first output node 12 and a second electronic switch 163 connected between the second circuit node k and the second output node 13. The first and second electronic switches 162, 163 are implemented as unidirectionally blocking electronic switches, for example. Each of the first and second switches 162, 163 switches on or off dependent on a respective drive signal S162, S163 provided by a current controller 52 included in the control circuit 18.

The current controller 52 is configured to control operation of the first and second electronic switches 162, 163 such that the current received at that one of the input nodes 11a, 11b, 11c that receives the intermediate voltage Vint (and that is connected to the current control circuit 16 through the phase selector 15) has a waveform that is in correspondence with the waveform of the intermediate voltage Vint. This is part of operating the first converter stage 1 as a PFC converter. Another part of operating the first converter stage 1 as a PFC converter includes controlling the output current I1 of the first converter stage 1 by the link circuit 3. The latter ensures that the current received at that one of the three input nodes 11a, 11b, 11c that receives the maximum input voltage has a waveform that is in correspondence with the waveform of the maximum input voltage Vmax and the current received at that one of the three input nodes 11a, 11b, 11c that receives the minimum input voltage has a waveform that is in correspondence with the waveform of the minimum input voltage Vmin. This is explained in detail herein further below.

Controlling the current received at that one of the input nodes 11a, 11b, 11c that receives the intermediate input voltage Vint includes controlling a current Ij through the inductor 161 of the current control circuit 16. Controlling the current Ij through the inductor 161 includes modulating a voltage Vkj across the inductor 161, wherein modulating the voltage Vkj across the inductor 161 includes modulating the electrical potential at the second circuit node (switched node) k by a switched mode operation of the first and second electronic switches 162, 163.

The current controller 52 is configured to switch on and off the first and second electronic switches 162, 163 complementarily. The electrical potential at the second circuit node k equals the electrical potential at the first output node 12 when the first electronic switch 162 is in the on-state and the second electronic switch 163 is in the off-state and equals the electrical potential at the second output node 13 when the first electronic switch 162 is in the off-state and the second electronic switch 163 is in the on-state.

FIG. 10 shows a block diagram of the phase selection controller 51 included in the control circuit 18. In this example, the phase selection controller 51 receives measured input voltage values Va′, Vb′, Vc′ wherein each of these measured input voltage values Va′, Vb′, Vc′ represents a respective one of the input voltages Va, Vb, Vc and can be obtained by measuring the respective input voltage Va, Vb, Vc using a conventional voltage sensor. Based on the measured input voltage values Va′, Vb′, Vc′ the phase selection controller 51 is configured to detect that one of the three input voltages Va, Vb, Vc which is instantaneously the intermediate input voltage Vint. Furthermore, the phase selection controller 51 is configured to generate the drive signals S15a, S15b, 15c of the electronic switches 15a, 15b, 15c in such a way that the electronic switch connected to the input node 11a, 11b, 11c receiving the intermediate voltage Vint is in the on-state and the other two electronic switches are in the off-state.

The operating principle of the phase selection controller 51 is illustrated in FIG. 11, which illustrates signal diagrams of the input voltages Va, Vb, Vc and the drive signals S15a, S15b, S15c over one period of the input voltages Va, Vb, Vc. Each of the drive signals S15a, S15b, S15c can have an on-level or an off-level, wherein the on-level switches on the respective switch 15a, 15b, 15c and the off-level switches off the electronic switch. Just for the purpose of illustration, in the example illustrated in FIG. 11, the on-level of the respective drive signal S15a, S15b, S15c is represented by a high signal level and the off-level is represented by a low signal level.

As can be seen from FIG. 11, each of the switches 15a, 15b, 15c is in the on-state during that time period in which the input node connected to the respective switch 15a, 15b, 15c receives the intermediate voltage Vint. Electronic switch 15a, for example, is in the on-state during those time periods in which voltage Va received at the input node 11a connected to the electronic switch 15a is the intermediate voltage Vint.

FIG. 12 shows a block diagram of the current controller 52 according to one example. It should be noted that this block diagram illustrates the functional blocks of the current controller 52 rather than a specific implementation. The functional blocks can be implemented in various ways. According to one example, the functional blocks are implemented using dedicated circuitry. According to another example, the current controller 52 is implemented using hardware and software. For example, the current controller 52 includes a microcontroller and software executed by the microcontroller. The same applies to the phase selection controller 51 illustrated in FIG. 11 and further control circuits explained herein further below.

Referring to FIG. 12, the current controller 52 generates an inductor current reference Ij*, which represents the desired average current Ij through the inductor 161. Referring to the above, the first and second electronic switches 162, 163 are operated in a switched mode. This includes operating the electronic switches 162, 163 in a plurality of successive drive cycles wherein, in each drive cycle, each of the electronic switches 162, 163 is in the on-state for a respective on-period and the off-state for a respective off-period. The “average current” is the average of the inductor current Ij over the duration of a respective drive cycle.

The inductor current reference Ij* is proportional to the intermediate voltage Vint and ensures that current at the circuit node receiving the intermediate voltage is proportional to the intermediate voltage Vint. The intermediate voltage Vint equals the voltage Vjn between the first circuit node j and the reference node n because, as explained above, the phase selection circuit 15 connects the first circuit node j to that one of the three input nodes 11a, 11b, 11c that receives the intermediate voltage Vint. The intermediate voltage Vint is represented by a voltage measurement value Vjn′, which is obtained by measuring the voltage Vjn using a conventional voltage sensor, for example. The proportionality factor between the intermediate voltage Vint (=Vjn) and the inductor current reference Ij* is given by a conductance reference G*. The inductor current reference Ij*is provided by a first multiplier 521 that receives the conductance reference G* and the measured intermediate voltage value Vjn′.

The conductance reference G* represents an instantaneous desired output power of the first converter stage 1 and is obtained by obtaining the instantaneous output power P1 and dividing the obtained instantaneous output power by an amplitude value. In the example illustrated in FIG. 12, a second multiplier 522 provides a measured output power value P1′. The measured output power value P1′ represents the instantaneous output power P1 of the first converter stage 1 and is obtained by multiplying a measured output voltage value V1′, which represents the output voltage V1 of the first converter stage 1, with a measured output current value I1′, which represents the output current I1 of the first converter stage 1.

A divider 523 provides the conductance reference G* by dividing the measured output power value P1′ by an amplitude value

$$\frac{3}{2} {\hat{V}}^{{}_{2}} ,$$

where \hat{V} denotes the amplitude of the input voltages Va, Vb, Vc.

Referring to FIG. 12, based on the inductor current reference Ij* and a measured inductor current value Ij′, which represents the current through the inductor 161, a subtractor 524 provides an inductor current error signal Ijerr. A controller 525, such as a PI controller provides an inductor voltage reference Vkj* based on the inductor current error signal Ijerr. The inductor voltage reference Vkj* represents the desired average voltage across the inductor 161 over one drive cycle of the switched mode operation of the first and second electronic switches 161, 162.

Referring to FIG. 12, an adder 526 generates a switched node voltage reference Vkl*. The switched node voltage reference Vkl* represents the desired average of the electrical potential at the second circuit node k over one drive cycle of the switched mode operation of the first and second electronic switches 161, 162. More specifically, the switched node voltage reference Vkl* represents the desired average voltage between the second circuit node k and the second output node 13 (which is additionally labeled by 1 in FIG. 7). The switched node voltage reference Vkl*is given by the inductor voltage reference Vkj* plus a measured voltage value Vjl′ of the voltage Vjl between the first circuit node j and the second output node 13.

Referring to FIG. 12, a divider 527 generates a duty cycle value d16 that defines a duty cycle of operation of the first and second electronic switches 162, 163 during one drive cycle. The duty cycle value d16 is given by the switched node voltage reference Vkl* divided by the measured output voltage value V1′ of the first converter stage 1. Based on the duty cycle value d16 a PWM modulator 528 generates the drive signals S161, S162 for the first and second switches 161, 162.

Referring to the above, the first converter stage 1 generates its output voltage V1 to be equal to the difference between the maximum output voltage Vmax and the minimum output voltage Vmin. Thus, instead of feeding the measured output voltage value V1′ to divider 527 it is also possible to provide a measured maximum output voltage value Vmax′ and a measured minimum output voltage value Vmin, calculate the difference Vmax′-Vmin′ of these measurement values and provide the difference to divider 527. This is illustrated in brackets in FIG. 12.

The duty cycle value d16 is a value between 0 and 1. In the example illustrated in FIG. 12, a duty cycle value of 0 represents a switched node voltage reference Vkl* being equal to 0 and a duty cycle value of 1 represents a switched node voltage reference Vkl* being equal to the output voltage V1. In this example, the duty cycle value d16 represents the duty cycle of operation of the first electronic switch 162 and the duty cycle of operation of the second electronic switch 163 is complementary to the duty cycle of the first electronic switch 162.

According to one example, a switching frequency of operating the first and second electronic switches 162, 163 is much higher than the frequency of the input voltages Va, Vb, Vc. According to one example, the switching frequency of the first and second electronic switches 162, 163 is between 10 kHz and several MHz, in particular between 10 kHz and several 100 kHz.

Implementing the first converter stage 1 as an IAF rectifier is only an example. According to another example illustrated in FIG. 13, the first converter stage 1 includes a rectifier with an active rectifier bridge 19 including three rectifier half-bridges 19a, 19b, 19c each including a first switch device 191a, 191b, 191c and a second switch device 192a, 192b, 192c. The switch devices 191a-192c are unidirectionally blocking devices, for example.

The rectifier illustrated in FIG. 13, which may also be referred to as six-switch rectifier (or B6 rectifier), is different from the IAF rectifier in that the rectifier half-bridges 19a, 19b, 19c are active rectifier half-bridges and in that between each of the input nodes 11a, 11b, 11c and the respective active rectifier half-bridge 19a, 19b, 19c a respective inductor 17a, 17b, 17c is connected. Each of the first switch devices 191a, 191b, 191c is connected between the respective inductor 17a, 17b, 17c and the first output node 12, and each of the second switch devices 192a, 192b, 192c is connected between the respective inductor 17a, 17b, 17c and the second output node 13.

A control circuit 181 is configured to control operation of the rectifier by generating drive signals S191a, S191b, S191c, S192a, S192b, S192c received by the first and second switch devices 191a, 191b, 191c, 192a, 192b, 192c. The control circuit 181 is configured to operate the rectifier in an operating mode in which (a) only one of the rectifier half-bridges 19a, 19b, 19c is operated in a switched mode in order to regulate the input current Ija, Ijb, Ijc at that one of the inputs 11a, 11b, 11c it is coupled to, and (b) the other two of the rectifier bridges 19a, 19b, 19c are statically operated such that one of the two electronic switches 191a, 191b, 191c, 192a, 192b, 192c is on the on-state and the other one of the two electronic switches 191a, 191b, 191c, 192a, 192b, 192c is in the off-state. This type of operating mode may be referred to as ⅓ mode.

In the following, the one of the input nodes 11a, 11b, 11c that instantaneously receives the maximum input voltage Vmax is referred to as maximum input node 11max, and the rectifier half-bridge connected to the maximum input node 11max is referred to as maximum half-bridge 19max; the one of the input nodes 11a, 11b, 11c that instantaneously receives the intermediate input voltage Vint is referred to as intermediate input node 11int, and the rectifier half-bridge connected to the intermediate input node 11int is referred to as intermediate half-bridge 19int; and the one of the input nodes 11a, 11b, 11c that instantaneously receives the minimum input voltage Vmin is referred to as minimum input node 11min, and the rectifier half-bridge connected to the minimum input node 11min is referred to as minimum half-bridge 19min. Furthermore, in the following 191max, 191int, 191min denote the first electronic switches in the maximum, intermediate, and minimum half-bridge 19max, 19int, 19min and S191max, S191int, S191min denote the respective control signals. Furthermore, 192max, 192int, 192min denote the second electronic switches in the maximum, intermediate, and minimum half-bridge 19max, 19int, 19min and S192max, S192int, S192min denote the respective control signals.

Furthermore, in the following the one of the inductors 17a, 17b, 17c connected to the intermediate input node 11int is referred to as intermediate inductor 17int, and the one of the inductor voltages Vkja, Vkjb, Vkjc that is the inductor voltage across the intermediate inductor 17int is referred to as intermediate inductor voltage Vkjint.

Referring to FIGS. 13, each of the rectifier half bridges 19a, 19b, 19c has a switched node ja, jb, jc. A switched node voltage Vja, Vjb, Vjc is the voltage between the respective switched node ja, jb, jc and the second output nodes 13. The switched node voltage of the intermediate half-bridge 11int is referred to as intermediate switched node voltage Vjint in the following.

According to one example, in the ⅓ mode, the control circuit 181 (a) operates the intermediate half-bridge 11int in the switched mode in order to regulate the input current Ijint received at the intermediate input node 11int; (b) statically operates the maximum half-bridge 11max such that the first electronic switch 191max is in the on-state and the second electronic switch 192max is in the off-state to couple the maximum input node 11max to the first output node 12; and (c) statically operates the minimum half-bridge 11min such that the first electronic switch 191min is in the off-state and the second electronic switch 192min is in the on-state to couple the minimum input node 11min to the second output node 13. Due to the inductors 17a, 17b, 17c coupled between the input nodes 11a, 11b, 11c and the rectifier half-bridges 19a, 19b, 19c the output voltage V1 of the first converter stage 1 according to FIG. 13 is not (automatically) equal to the difference between the maximum input voltage Vmax and the minimum input voltage Vmin. This is different from the first input stage according to FIG. 7. This is because (low) voltage drops across the inductors 17a, 17b, 17c occur.

FIG. 14 shows a block diagram of one example of the control circuit 181 configured to control operation of the rectifier circuit 19 according to FIG. 13. Referring to FIG. 14, the control circuit 181 includes a current controller 82. The current controller 82 is configured to regulate the input current Ijint received at the intermediate input 11int. For this, the current controller 82 controls operation of the first and second electronic switches 191int, 192int included in the intermediate half-bridge by providing respective control signals S191int, S192int. Furthermore, the control circuit 181 includes a rectifier controller 83. The rectifier controller 83 controls operation of the maximum half-bridge 19max and the minimum half-bridge 19min by generating the respective control signals S191max, S192max, S191min, S192min such that, in the maximum half-bridge 19max, the first electronic switch 191max is in the on-state and the second electronic switch 192max is in the off-state, and, in the minimum half-bridge 19min, the first electronic switch 191min is in the off-state and the second electronic switch 192min is in the on-state.

The rectifier controller 83 is optional. Referring to the above, the electronic switches 191a, 191b, 191c, 192a, 192b, 192c included in the rectifier half bridges 19a, 19b, 19c are unidirectionally blocking electronic switches, for example. Thus, it is also possible, when operating the rectifier 19 in the ⅓ mode, to operate the electronic switches in the maximum half-bridge 11max and the minimum half-bridge 11min in the off-state. In this case, the rectifier element (diode) of the first electronic switch 191max in the maximum half-bridge 19max and the rectifier element (diode) of the second electronic switch 192min in the minimum half-bridge 19min automatically conduct.

The operating principle of the current controller 82 is illustrated in FIG. 15, which shows a block diagram of the current controller 82 according to one example. The current controller 82 according to FIG. 15 is based on the current controller 52 shown in FIG. 12. In the current controller 82 illustrated in FIG. 15, multipliers 821, 822 correspond to multipliers 521, 522 according to FIG. 7, dividers 823, 827 correspond to dividers 523, 527 according to FIG. 7, subtractor 824 correspond to subtractor 524 according to FIG. 7, subtractor 826 corresponds adder 526 according to FIG. 7, controller 825 corresponds to controller 525 according to FIG. 7, and PWM modulator 828 corresponds to PWM modulator 528 according to FIG. 7.

In the current controller 82 according to FIG. 15, multiplier 821 generates an inductor current reference Ijint*, which represents the desired average current Ijint through the inductor coupled to the intermediate input 11int. Referring to the above, the first and second electronic switches 191int, 192int in the intermediate half-bridge 19int are operated in a switched mode. This includes operating the electronic switches 191int, 192int in a plurality of successive drive cycles wherein, in each drive cycle, each of the electronic switches 191int, 192int is in the on-state for a respective on-period and the off-state for a respective off-period. The “average current” is the average of the inductor current Ijint over the duration of a respective drive cycle.

The inductor current reference Ijint* is proportional to the intermediate voltage Vint. The intermediate voltage Vint is represented by a voltage measurement value Vint′, which is obtained by measuring the intermediate voltage Vint using a conventional voltage sensor, for example. The proportionality factor between the intermediate voltage Vint and the inductor current reference Ijint* is given by a conductance reference G*. The inductor current reference Ijint*is provided by the first multiplier 821 that receives the conductance reference G* and the measured intermediate voltage value Vint′.

Referring to the above, the intermediate voltage is the one of the input voltages Va, Vb, Vc which instantaneously has a voltage level that is between the voltage levels of the other two input voltages. In addition to the current controller 82, the control circuit 181 may include a mapping circuit (not shown) that receives measurement values of the input voltages Va, Vb, Vc and also measurement values of the input currents Ija, Ijb. Ijc. The mapping circuit is configured to detect which one of the input voltages Va, Vb, Vc is the intermediate input voltage Vint, and to forward the voltage measurement value Vint′ of the intermediate input voltage Vint and the current measurement value Ijint′ of the corresponding intermediate input current Ijint to the current controller 82.

In the current controller 82 according to FIG. 15, the conductance reference G* represents an instantaneous output power of the first converter stage 1 and is obtained by obtaining the instantaneous output power P1 and dividing the obtained instantaneous output power by an amplitude value.

In the example illustrated in FIG. 15, multiplier 822 provides a measured output power value P1′, which represents the instantaneous output power P1 of the first converter stage 1 and is obtained by multiplying a measured output voltage value V1′, which represents the output voltage V1 of the first converter stage 1, with a measured output current value I1′, which represents the output current I1 of the first converter stage 1. Furthermore, divider 823 provides the conductance reference G* by dividing the measured output power value P1′ by an amplitude value

$$\frac{3}{2} {\hat{V}}^{{}_{2}} ,$$

where \hat{V} denotes the amplitude of the input voltages Va, Vb, Vc.

It should be noted that in the example illustrated in FIG. 15, as well as in the example illustrated in FIG. 12, generating the conductance reference G* based on the measured output power P1′ of the first converter stage 1 is only an example. Referring to the above, the link circuit 3 is configured to regulate the output voltage Vo*. For this, an output power reference P1* of the first converter stage 1 may be determined, which is explained with reference to FIG. 21 herein further below. The output power reference P1* of the first converter stage 1 defines the desired output power of the first converter stage 1 and essentially equals a desired output power Po* of the power converter. Instead of obtaining the conductance reference G* based on the measured output power P1′ of the first converter stage 1, it is also possible to generate the conductance reference G* based on the output power reference P1*. In this case, multipliers 522 and 822 in the current controllers according to FIGS. 12 and 15 are omitted and the measured output power P1′ is replaced by the output power reference P1*.

Referring to FIG. 15, a subtractor 824 provides an inductor current error signal Ijerr, which is based on the inductor current reference Ijint* and a measured inductor current value Ijint′. The latter represents the current Ijint through the intermediate inductor 17int. A controller 825, such as a PI controller provides an inductor voltage reference Vkjint* based on the inductor current error signal Ijerr. The inductor voltage reference Vkjint* represents the desired value of the average voltage across the intermediate inductor 17int over one drive cycle of the switched mode operation of the intermediate half-bridge 19int.

Referring to FIG. 15, a subtractor 826 generates a switched node voltage reference Vjint*. The switched node voltage reference Vjint* represents the desired (average) voltage level of the intermediate switched node voltage Vjint over (at least) one drive cycle of the switched mode operation of the intermediate half-bridge 19int. The switched node voltage reference Vjint* is given by a difference Vint′-Vmin′ between a measured voltage value Vint′ of the intermediate voltage Vint and a measured voltage value Vmin′ of the minimum input voltage Vmin minus the intermediate inductor voltage reference Vkjint*.

Referring to FIG. 15, divider 827 generates a duty cycle value d19 that defines a duty cycle of operation of the first and second electronic switches 191int, 192int in the intermediate half-bridge 19int. The duty cycle value d19 is given by the switched node voltage reference Vjint* divided by a calculated voltage value, which is given by the measured maximum output voltage value Vmax′ minus the measured minimum output voltage value Vmin′. This is different from the current controller 52 according to FIG. 12, in which divider 527 receives the measured output voltage V1′ of the first converter stage 1. Referring to the above, in the first converter stage 1 according to FIG. 13, the output voltage V1 of the first converter stage 1 is not automatically equal to the maximum input voltage Vmax minus the minimum input voltage Vmin. This is considered by feeding Vmax′-Vmin′ (instead of V1′) into divider 827.

Based on the duty cycle value d19 PWM modulator 528 generates the drive signals S191int, S192int for the first and second switches 191int, 192int in the intermediate half-bridge 19int. The duty cycle value d19 is a value between 0 and 1. According to one example, duty cycle value d19 represents the duty cycle of operation of the first electronic switch 191int and the duty cycle of operation of the second electronic switch 192int is complementary to the duty cycle of the first electronic switch 191int.

Referring to the above, the second converter stage 2 is configured to generate its output voltage Vo, which is the output voltage of the power converter, to be essentially proportional to the input voltage V2 received by the second converter stage 2. According to one example, the second converter stage 2 further includes a transformer which provides for a potential barrier between the input of the power converter, which is formed by the input nodes 11a, 11b, 11c of the first converter stage 1, and the output of the power converter, which is formed by the output nodes 23, 24 of the second converter stage 2. If, however, a potential barrier between the input and the output is not required, it is also possible to implement the second converter stage 2 without a transformer.

The second converter stage 2 can be implemented in various ways. That is, various kinds of power converters with or without transformer can be used for implementing the second converter stage 2. Just as an example, one possible implementation of the second converter stage 2 is illustrated in FIG. 16.

In the example illustrated in FIG. 16, the second converter stage 2 includes a resonant converter with a switching circuit 25 connected to the input nodes 21, 22, a rectifier circuit 27 connected to the output nodes 23, 24, and a resonant circuit 26 with a transformer 260 connected between the switching circuit 25 and the rectifier circuit 27. Furthermore, the second converter stage 2 may include an input capacitor 281 connected between the input nodes 21, 22 and an output capacitor 282 connected between the output nodes 23, 24.

Referring to FIG. 16, the switching circuit 25 includes a first switched node 251 connected to a first input node 261 of the resonant circuit 26 and a second switched node 252 connected to a second input node 262 of resonant circuit 26. A first electronic switch 253 is connected between the first switched node 251 and the first input node 21; a second electronic switch 254 is connected between the first switched node 251 and the second input node 22; a third electronic switch 255 is connected between the second switched node 252 and the first input node 21; and a fourth electronic switch 256 is connected between the second switched node 252 and the second input node 22. Each of the electronic switches 253, 254, 255, 256 switches on or off dependent on a respective drive signal S253, S254, S255, S256 generated by a control circuit 28.

According to one example, each of the electronic switches 253, 254, 255, 256 is a unidirectionally blocking electronic switch.

In the example illustrated in FIG. 16, the resonant circuit 26 is an LLC circuit that includes a series circuit with a first inductor 265, a second inductor 266 connected in parallel with a first winding 268 of a transformer 260, and a capacitor 267, wherein this series circuit is connected between the first and second input nodes 261, 262. The transformer 260 further includes a second winding 269 that is inductively coupled with the primary winding 268. According to one example, the first winding and the second winding 268, 269 have same winding senses. The second inductor 266 may be a discrete inductor in addition to the primary winding 268 of the transformer 260. This, however, is only an example. According to another example, the second inductor 266 is an inherent part of the primary winding 268, so that a discrete inductor in addition to the primary winding 268 and in parallel to the primary winding 268 is dispensable.

Referring to FIG. 16, the second winding 269 is coupled between a first output node 263 and a second output node 264 of the resonant circuit 26. The first output node 263 is connected to a first rectifier node 271 of the rectifier circuit 27, and the second output node 264 is connected to a second rectifier node 272 of the rectifier circuit 27.

Referring to FIG. 16, the rectifier circuit 27 further includes a first rectifier element 273 connected between the first rectifier node 271 and the first output node 23; a second rectifier element 274 connected between the first rectifier node 271 and the second output node 24; a set rectifier element 275 connected between the second rectifier node 272 and the first output node 23; and a fourth rectifier element 276 connected between the second rectifier node 272 and the second output node 24. Just for illustration purposes, the rectifier elements 273, 274, 275, 276 are implemented as passive rectifier elements, such as diodes in the example illustrated in FIG. 16. This, however, is only an example. According to another example (not illustrated) the rectifier elements are synchronous rectifier elements, such as rectifier elements of the type explained with reference to FIGS. 8A and 8B herein before. In combination with synchronous rectifier elements in the first converter stage 1, this may facilitate a bidirectional power flow through the power converter.

In the resonant converter according to FIG. 16, the control circuit 28 is configured to control operation of the electronic switches 253, 254, 255, 256 of the switching circuit 25 such that the switching circuit 25 provides an alternating voltage V26 between the first and second switched nodes 251, 252 in such a way that a voltage level of the alternating voltage V26 either equals the voltage level of the input voltage V2 or the negated voltage level of the input voltage V2. An alternating voltage V26 of this type is illustrated in FIG. 17.

FIG. 17 shows a signal diagram of an alternating rectangular voltage generated by the switching circuit 25 based on the input voltage V2, wherein the signal level of the alternating voltage V26 alternatingly equals the voltage level of the input voltage V2 or the negated voltage level of the input voltage V2. For generating the alternating voltage V26 to have the voltage level of the input voltage V2, the control circuit 28 switches on the first and fourth electronic switches 253, 256 and switches off the second and third electronic switches 254, 255, and, for generating the alternating voltage V26 to have the negated voltage level of the input voltage V2, the control circuit 28 switches on the second and third electronic switches 254, 255 and switches off the first and fourth electronic switches 253, 256. Thus, the control circuit 26 synchronously switches on and off the first and fourth electronic switches 253, 256 and synchronously switches on and off the second and third electronic switches 254, 255, wherein the first and fourth electronic switches 253, 256 are operated complementarily to the second and third electronic switches 254, 255. A duty cycle of operation of each of the electronic switches 253-256 is essentially 50%. In fact, the duty cycle may be slightly lower than 50% as there may be dead times between switching off one pair of the electronic switches 253-256 and switching on the other pair of the electronic switches 253-256 in order to avoid cross currents.

According to one example, a switching frequency f2, which is the reciprocal of the time duration T2 of one drive cycle of operating the electronic switches 253-256 is fixed, resulting in the output voltage Vo being at least approximately proportional to the input voltage V2. Operating the second converter stage 2 at a fixed frequency is equivalent to operating the second converter stage 2 in an unregulated fashion.

According to one example, the switching frequency f2 at least approximately equals the resonant frequency of the resonant circuit 26. In this case, the resonant circuit operates at a high efficiency. Furthermore, the proportionality factor between the output voltage Vo and the input voltage V2 is essentially given by the ratio between the number of turns N1 of the primary winding 268 and the number of turns N2 of the secondary winding 269. That is,

$$V o = \frac{N 2}{N 1} \cdot V 2 , \qquad ( 5 )$$

so that, referring to equation (2),

$$n = \frac{N 1}{N 2} . \qquad ( 6 )$$

It should be noted that implementing the second converter stage 2 to include a resonant converter, such as an LLC converter, is only an example. Any other type of power converter that can be operated in an unregulated fashion such that its output voltage is at least approximately proportional to the input voltage can be used as well. Further examples of such power converters include any kind of unregulated DC transformers (often referred to as DCX), a DAB (Dual Active Bridge) converter, or the like.

FIG. 18 schematically illustrates one example of the link circuit 3. In the example illustrated in FIG. 18, the link circuit 3 includes a voltage and current regulator 6 connected to the link nodes 31, 32 and configured to regulate the output voltage Vo of the second converter stage 2 and the output current I1 of the first converter stage 1. The output current I1 of the first converter stage 1 is received by the link circuit 3 at the link nodes 31, 32. The link circuit 3 further includes a voltage regulator 7 that is coupled to the supply nodes 33, 34 and configured to provide an auxiliary voltage Vh to supply nodes 61, 62 of the voltage and current regulator 6. The auxiliary voltage Vh is used by the voltage and current regulator 6 to regulate the output current I1.

FIG. 19 illustrates one example of the voltage and current regulator 6. In this example, the voltage and current regulator 6 includes a switching circuit 63 with a first switched node x coupled to the first link node 31 and a second switched node y coupled to the second link node 32. One of the first and second switched nodes x, y is coupled to the respective link node 31, 32 through an inductor 64 which. The inductor 64 is used by the voltage and current regulator 6 to form the output current I1 of the first converter stage 1. According to one example (illustrated in FIG. 19), the inductor 64 is connected between the first switched node x and the first link node 31. According to another example (not illustrated) the inductor 64 is connected between the second switched node y and the second link node 32. Optionally, a capacitor 65 is connected between the first and second link nodes 31, 32.

Referring to FIG. 19, the switching circuit 63 further includes a first electronic switch 631 connected between the first switched node x and the first supply node 61; a second electronic switch 632 connected between the first switched node x and the second supply node 62; a third electronic switch 633 connected between the second switched node y and the first supply node 61; and a fourth electronic switch 634 connected between the second switched node y and the second supply node 62. Each of the electronic switches 631, 632, 633, 634 switches on or off dependent on a respective control signal S631, S632, S633, S634 provided by a control circuit 66.

According to one example, each of the electronic switches 631, 632, 633, 634 of the switching circuit 63 is a unidirectionally blocking electronic switch. According to one example illustrated in FIG. 20, each of the electronic switches is a GaN switch, such as a GaN (gallium nitride) HEMT (high electron-mobility transistor). In FIG. 20, reference number 63x represents an arbitrary one of the electronic switches 631, 632, 633, 634, and S63x represents the respective control signal.

In the voltage and current regulator 6 according to FIG. 19, the control circuit 66 controls operation of the switching circuit 63 to modulate a switched node voltage Vxy, which is a voltage between the first and second switched nodes x, y, in order to adjust the output current I1 of the first converter stage 1. Modulating the switched node voltage Vxy includes operating the switching circuit 63 in a plurality of successive drive cycles in order to adjust an average of the switched node voltage Vxy (over the duration of one or more drive cycles) to have a predefined value. The average switched node voltage Vxy is adjusted by generating the switched node voltage Vxy to have one of the following three voltage levels for a predefined duration: (a) the voltage level of the auxiliary voltage Vh; (b) the negated (inverted) voltage level (−Vh) of the auxiliary voltage Vh; or (c) zero. The switched node voltage Vxy has the voltage level (Vh) of the auxiliary voltage Vh when the first electronic switch 631 and the fourth electronic switch 634 are switched on and the second electronic switch 632 and the third electronic switch 633 are switched off; the switched node voltage Vxy has the negated voltage level (−Vh) of the auxiliary voltage Vh when the second electronic switch 632 and the third electronic switch 633 are switched on and the first electronic switch 631 and the fourth electronic switch 634 are switched off; and the switched node voltage Vxy is zero when either the first electronic switch 631 and the third electronic switch 633 are switched on and the second electronic switch 632 and the fourth electronic switch 634 are switched off, or the first electronic switch 631 and the third electronic switch 633 are switched off and the second electronic switch 632 and the fourth electronic switch 634 are switched on. In each drive cycle, the control circuit 66 selects at least one of these voltage levels for a certain duration in order to obtain the desired average of the switched node voltage Vxy. In order to achieve a positive (average) switched node voltage Vxy, the control circuit 66 may alternate the switched node voltage Vxy between the voltage level of the auxiliary voltage Vh and zero or between the voltage level of the auxiliary voltage Vh and the voltage level of the negated auxiliary voltage Vh. In order to achieve a negative (average) switched node voltage Vxy, the control circuit 66 may alternate the switched node voltage Vxy between the voltage level of the negated auxiliary voltage Vh and zero or between the voltage level of the auxiliary voltage Vh and the voltage level of the negated auxiliary voltage Vh. Basically, any average voltage level of the switched node voltage Vxy between the negated voltage level-Vh and the voltage level Vh of the auxiliary voltage Vh can be adjusted.

The current path of the output current I1 of the first converter stage 1 (which is the input current of the second converter stage 2) through the voltage and current regulator 6 is dependent on the operating state of the switching circuit 63. When the switching circuit 63 is controlled such that the switched nodes x, y are connected (and the switched node voltage Vxy is zero) the current I1 flows via the inductor 64 and only through the switching circuit 63. Referring to the above, the switching circuit 63 is in this operating state when the first and third electronic switches 631, 633 are in the on-state or the second and fourth electronic switches 632, 634 are in the on-state.

When the switching circuit 63 is controlled such that the switched nodes x, y are not connected (and the switched node voltage Vxy is either Vh or −Vh) the current I1 flows through the inductor 64, the two switches that are in the on-state, and via the supply nodes 61, 62 through the auxiliary voltage regulator 7. Referring to the above, the two switches that are in the on-state are either the first switch 631 and the fourth switch 634 (so that the switched node voltage Vxy is Vh), or the second switch 632 and the third switch 633 (so that the switched node voltage Vxy is −Vh).

The duration of one drive cycle of operating the switching circuit 63 is much shorter than the duration of one period of the input voltages Va, Vb, Vc. That is, a switching frequency of the electronic switches 631-634 in the switching circuit 63 is much higher than the frequency of the input voltages Va, Vb, Vc. According to one example, the switching frequency is in a range of between 10 kHz and several MHz, in particular between 10 kHz and several 100 kHz.

FIG. 21 illustrates one example of the control circuit 66 of the voltage and current controller 6, which may also be referred to as voltage and current controller 66. The control circuit 66 is configured to control operation of the voltage and current controller 6 and thus the kink circuit 3 in such a way that the output voltage Vo of the second converter stage 2, which is the output voltage of the power converter, and the output current I1 of the first converter stage 1 are regulated. It should be noted that FIG. 21 illustrates the functionality of the control circuit 66 rather than a specific implementation.

Referring to FIG. 21, the control circuit 66 generates an output current reference I1* which represents a desired (instantaneous) current level of the output current I1 of the first converter stage 1. The output current reference I1* is given by an output power reference P1* of the first converter stage 1 divided by a measured output voltage value V1′ of the first converter stage 1 and is provided by a divider 663 that receives the output power reference P1* and the measured output voltage value V1′. The output power reference P1* represents a desired output power of the first converter stage 1, and the measured output voltage value V1′ represents the (instantaneous) voltage level of the output voltage V1 of the first converter stage 1 and can be obtained using a conventional voltage sensor, for example.

The output power reference P1* is provided by a controller 662, such as a PI controller, that receives an output voltage error signal Voerr from a subtractor 661. The output voltage error signal is given by an output voltage reference Vo* minus a measured output voltage value Vo′. The output voltage reference Vo* defines the desired voltage level of the output voltage Vo and is part of regulating the output voltage Vo. According to one example, the output voltage reference Vo* is fixed and predefined. The measured output voltage value Vo′ represents the instantaneous voltage level of the output voltage Vo and can be obtained using a conventional voltage sensor, for example.

In the steady-state of the power converter, the output power reference P1* is essentially constant. Due to the six-pulse waveform of the output voltage V1 of the first converter stage 1 explained hereinabove, the output current reference I1*, which is obtained by dividing the output power reference P1* by the measured output voltage value V1′, has the inverted six-pulse waveform illustrated in FIGS. 4 and 6. The output current I1 of the first converter stage 1 is regulated to be in accordance with the output current reference I1* to have the inverted six-pulse waveform. Assuming that power losses in the first converter stage 1 are negligible as compared to the overall power processed by the first converter stage 1, the output power P1 of the first converter stage essentially equals the input power Pabc of the first converter stage 1. Referring to FIG. 3, the input power Pabc of the first converter stage is essentially constant when the input currents Ia, Ib, Ic are regulated to have the same signal waveform as the input voltages Va, Vb, Vc.

As explained above, the input current received at the input node receiving the intermediate input voltage Vint is adjusted by the first converter stage 1 to have the same signal waveform as the intermediate voltage Vint. That the input current received at the input node receiving the highest input voltage Vmax has the same signal waveform as the highest input voltage Vmax and the input current received at the input node receiving the lowest input voltage Vmin has the same signal waveform as the lowest input voltage is achieved by regulating the overall output current I1 of the first converter stage 1 by the link circuit 3 to have the inverted six-pulse waveform illustrated in FIGS. 4 and 6.

Referring to FIG. 21, a subtractor 664 calculates an output current error signal Ierr based on the output current reference I1* and a measured output current value I1′. The measured output current value I1′ represents an (instantaneous) current level of the output current I1 of the first converter stage 1 and can be obtained using a conventional current sensor, for example. A controller, such as a PI controller 665, receives the output current error signal Ierr and provides an inductor voltage reference VLf*. The inductor voltage reference VLf* represents a desired average voltage level of a voltage Vlf across the inductor 64 connected between the first switched node x and the first link node 31. This voltage is generated by the switching circuit 63. Referring to the above, the switching circuit 63 is operated in a switched mode. “Average voltage level” of the voltage across the inductor denotes the average of the voltage level over the duration of at least one drive cycle of the switched mode operation of the switching circuit 63.

Referring to FIG. 21, a subtractor 666 subtracts the inductor voltage reference VLf* from a measured link voltage value V3′ to obtain a switched node voltage reference Vxy*. The measured link voltage value V3′ represents the link voltage V3 and can be obtained by measuring the link voltage V3 using a conventional voltage sensor, for example. The switched node voltage reference Vxy* represents a desired average voltage level of the switched node voltage Vxy. “Average voltage level” denotes the average of the voltage level over the duration of at least one drive cycle of the switched mode operation of the switching circuit 63. Both the link voltage V3 and the inductor voltage reference Vlf* can be positive or negative. Thus, the switched node voltage reference Vxy* can be positive or negative in order to achieve a positive or negative (average) switched node voltage Vxy, whatever is necessary to regulate the output current I1 of the first converter stage 1.

It should be noted that feeding the measured link voltage value V3′ to subtractor 666 relates to a voltage and current controller 66 in a link circuit used in connection with a first converter stage 1 (IAF rectifier) according to FIG. 7. Referring to the above, in this first converter stage 1, the output voltage V1 is automatically a pulsating output voltage with a voltage level given by the voltage level of the instantaneously maximum input voltage Vmax and the instantaneously minimum input voltage Vmin, so that the link voltage V3 automatically has a pulsating waveform.

Referring to the above, in a first converter stage 1 of the type illustrated in FIG. 13 the output voltage does not automatically have a signal waveform that is given by the difference between the voltage levels of the maximum input voltage Vmax and the minimum input voltage Vmin. Thus, in a link circuit 3 used in connection with a first converter stage 1 of this type, the subtractor 666 in the voltage and current controller 66 receives a calculated voltage value that is given by the measured voltage value Vmax′ of the maximum input voltage Vmax minus the measured voltage value Vmin′ of the minimum input voltage Vmin minus the measured input voltage value V2′ of the input voltage V2 of the second converter stage 2. This is indicated in brackets in FIG. 21. In each case, the output current I1 of the first converter stage 1 is regulated by the link circuit 3 in order to achieve a PFC functionality of the first converter stage 1.

It should be noted that instead of measuring the input voltage V2 in order to obtain the measured input voltage value V2′ it is also possible to measure the output voltage Vo and multiply the obtained output voltage measurement value Vo′ by the proportionality factor n introduced by the second converter stage 2 (V2′=n·Vo′).

A divider 667 divides the switched node voltage reference Vxy* by a measured auxiliary voltage value Vh′ to provide a duty cycle value d63 for operating the switching circuit 63. The measured auxiliary voltage value Vh′ represents the voltage level of the auxiliary voltage Vh and is obtained by measuring the auxiliary voltage Vh using a conventional voltage sensor, for example.

Referring to FIG. 21, a PWM modulator 668 receives the duty cycle value d63 and generates the control signals S631-S634 for operating the electronic switches 631-634 in the switching circuit 63 such that the average switched node voltage Vxy is in accordance with the switched node voltage reference Vxy*.

As explained herein before, the link circuit 3 regulates the output voltage Vo of the power converter and the output current I1 of the first converter stage 1. For this, as explained with reference to FIG. 21, the voltage and current regulator 6 controlled by the voltage and current controller 66 adjusts the output power P1 (and thus the input power Pabc) of the first converter stage 1 such that the output power P1 is in accordance with the output power reference P1*, wherein the output power reference P1* is adjusted such that the output voltage Vo of the power converter is in accordance with the desired output voltage reference Vo*. Furthermore, the voltage and current controller 66 adjusts the output current I1 to be in accordance with the output current reference I1*, which has the desired six-pulse current waveform.

As the second converter stage 2 operates in an unregulated fashion such that its input voltage V2 is at least approximately proportional to the regulated output voltage Vo, the voltage level of the input voltage V2 is defined by the output voltage Vo. Furthermore, the link voltage V3, in accordance with equation (1), is given by the output voltage V1 minus the input voltage V2 of the second converter stage 2,

$$V 3 = V 1 - V 2 . \qquad ( 7 )$$

If, for example, the RMS value of the input voltages Va, Vb, Vc increases, the DC component of the pulsating output voltage V1 increases. This results in a reduction of the DC component of the output current reference I1* (see, FIG. 21) and thus the output current I1 of the first converter stage. If, for example, the RMS value of the input voltages Va, Vb, Vc decreases, the DC component of the pulsating output voltage V1 decreases (if the input power and the output power remain unchanged). This results in an increase of the DC component of the output current reference I1* and thus the output current I1. In both cases, the input voltage V2 is maintained at an essentially fixed voltage level that is dependent on the voltage level of the regulated output voltage Vo, so that a DC component of the link voltage V3 either increases or decreases. If the output power Po of the power converter (and thus the input power Pabc and the output power P1 of the first converter stage) remains unchanged, a reduced DC component of the output current I1 results in a reduced (average) input power P2 and an increased DC component of the output current I1 results in an increased (average) input power P2 of the second converter stage 2. In each case, the input power P2 of the second converter stage 2 is positive.

Furthermore, the link circuit 3 is configured to bypass the input of the second converter stage 2 and provide for a power flow between its link nodes 31, 32 and its supply nodes 33, 34 which are coupled to internal circuit nodes of the second converter stage 2 or the output nodes 24, 25 of the second converter stage 2. The link power 3 processed by the link circuit 3 is given by the difference between the output power P1 of the first converter stage 1 and the input power P2 of the second converter stage 2. Referring to the above, the output power P1 of the first converter stage 1 is adjusted to maintain the output Po power and output voltage Vo of the power converter at a predefined voltage level. Thus, the power bypassed by the link circuit 3, despite a varying input power P2 of the second converter stage2, helps to maintain the output power Po and thus the output voltage Vo at a respective predefined level.

Referring to the above, an input power (linked power) P3 of the link circuit 3, which is given by the output current I1 multiplied with the link voltage V3 can be positive or negative. Whether the link power P3 is positive or negative is dependent on whether the link voltage V3 is positive or negative, whatever results from the output voltage V1 of the first converter stage 1 and the input voltage V2 of the second converter stage 2 in accordance with equation (7). Usually, the power P3 processed by the link circuit 3 is much lower than the power P2 processed by the second converter stage 2. According to one example, the power P3 processed by the link circuit 3 is less than 20% or less than 10% of the power P2 processed by the second converter stage 2.

The power P3 processed by the link circuit 3 flows through the voltage and current regulator 6 and the auxiliary voltage regulator 7 between the link nodes 31, 32 and the supply nodes 33, 34. Referring to the above, the supply nodes 33, 34 are coupled to the second converter stage 2, so that the power flow through the link circuit 3 continues to the second converter stage 2.

FIG. 22 illustrates one example of the auxiliary voltage regulator 7 configured to provide the regulated auxiliary voltage Vh and FIG. 23 illustrates one example of a control circuit 75 configured to control operation of the voltage regulator 7 such that the auxiliary voltage Vh is regulated to be essentially constant. The control circuit 76 may also be referred to as auxiliary voltage controller 76.

The auxiliary voltage regulator 7 illustrated in FIG. 22 is configured to receive an alternating voltage V41 at the supply nodes 33, 34 of the link circuit and is configured to regulate the auxiliary voltage Vh by phase shift modulating a switch half-bridge included in the auxiliary voltage regulator 7. However, implementing the auxiliary voltage regulator 7 in this way is only an example. Any kind of voltage regulator that is configured to regulate the output voltage Vh to have a predefined reference value and that is configured to provide for a bidirectional power flow may be used as well. “Bidirectional power flow” includes that the auxiliary voltage regulator 7 may receive power at the supply nodes 33, 34 or provide power to the supply nodes 33, 34, dependent on whether the link power P3 received at the link nodes 31, 32 is positive or negative. When the link power P3 is positive, the auxiliary voltage regulator 7 transfers power received from the voltage and current regulator 6 to the supply nodes 33, 34. When the link power P3 is negative, the auxiliary voltage regulator 7 receives power from the supply nodes 33, 34 and transfers the power to the voltage and current regulator 6.

Referring to FIG. 22, the auxiliary voltage regulator 7 includes first and second auxiliary voltage nodes 71, 72 between which the auxiliary voltage Vh is available. A capacitor half-bridge 73 with a first capacitor 731 and a second capacitor 732 is connected between the first and second auxiliary voltage nodes 71, 72 and provides the auxiliary voltage Vh. The first capacitor 731 is connected between a tap z of the capacitor half-bridge 73 and the first auxiliary voltage node 71, and the second capacitor 732 is connected between the tap z and the second auxiliary voltage node 72.

Furthermore, the auxiliary voltage regulator 7 includes a switch half-bridge 74 with a first switch 741 and a second switch 742 connected between the first and second auxiliary voltage nodes 71, 72. The first switch 741 is connected between a switched node w of the switch half-bridge 74 and the first auxiliary voltage node 71, and the second switch 742 is connected between the switched node w and the second auxiliary voltage node 72. One of the tap z and the switched node w is coupled to a first one of the supply voltage nodes 33, 34, and the other one of the tap z and the switched node w is coupled to a second one of the supply voltage nodes 33, 34. Furthermore, one of the tap z and the switched node is coupled to the respective supply voltage node 33, 34 through an inductor 75. Just for the purpose of illustration, in the example illustrated in FIG. 22, the tap z is connected to the second supply voltage node 34 and the switched node w is connected to the first supply voltage node 33 through the inductor 75.

According to one example, each of the first and second switches 741, 742 is a unidirectionally blocking electronic switch.

Each of the first and second electronic switches 741, 742 switches on or off dependent on a drive signal S741, S742 provided by a control circuit 76, which may also be referred to as auxiliary voltage controller 76. The auxiliary voltage controller 76 is configured to control operation of the first and second electronic switches 741, 742 such that the auxiliary voltage Vh is regulated to have a predefined voltage level.

One example of the auxiliary voltage controller 76 is illustrated in FIG. 23. FIG. 23 shows a block diagram of the auxiliary voltage controller 76 and illustrates the functionality of the auxiliary voltage controller 76 rather than a specific implementation.

Referring to FIG. 23, the auxiliary voltage controller 76 generates an auxiliary voltage error signal Vherr that represents a difference between an auxiliary voltage reference Vh* and a measured auxiliary voltage value Vh′. The auxiliary voltage error signal Vherr is provided by a subtractor 761 that receives the auxiliary voltage reference Vh* and the measured auxiliary voltage value Vh′. The auxiliary voltage reference Vh* represents a desired voltage level of the auxiliary voltage Vh, and the measured auxiliary voltage value Vh′ represents the instantaneous voltage level of the auxiliary voltage Vh and is obtained, for example, by measuring the auxiliary voltage Vh using a conventional voltage sensor.

The auxiliary voltage Vh is regulated by controlling a capacitor current ICh into the capacitor half-bridge 73. For this, a controller 762, such as PI controller, provides a capacitor voltage reference ICh* based on the auxiliary voltage error signal Vherr. The capacitor voltage reference ICh* represents the desired current level of the current ICh into the capacitor half-bridge 73 that is required to achieve that the auxiliary voltage Vh at least approximately equals the auxiliary voltage reference Vh*. Based on the capacitor current reference ICh* a multiplier 763 calculates a capacitor power reference PCh* by multiplying the capacitor current reference ICh* with the auxiliary voltage reference Vh*. The capacitor power reference PCh* represents a desired power level of power received by the capacitor half-bridge 73 or provided by the capacitor half-bridge 73. Power is received by the capacitor half-bridge 73 when the capacitor current ICh is positive (that is, flows in the direction illustrated in FIG. 22) and is provided by the capacitor half-bridge 73 when the capacitor current ICh is negative (that is, flows in the direction opposite the direction illustrated in FIG. 22).

Based on the capacitor power reference PCh* and the link power P3, the auxiliary voltage controller 76 provides a power reference P7* of the auxiliary voltage regulator 7. The power reference P7* represents a desired power level of power P7 received at the supply nodes 33, 34 of the link circuit 3. This power P7 can be positive or negative. Usually, the capacitor power reference PCh* is much lower than the link power P3, so that the power P7 at the supply nodes 33, 34 is essentially given by the link power P3. In the present example, when the power P7 at the supply nodes 33, 34 is positive, the auxiliary voltage regulator 7 provides power to the coupler 4, and when the power P7 at the supply nodes 33, 34 is negative, the auxiliary voltage regulator receives power from the coupler 4.

In the example illustrated in FIG. 23, the power reference P7* is provided by a subtractor 764 that receives the capacitor power reference PCh* and a link power reference P3*. The link power reference P3* represents a desired power level of power at the link nodes 31, 32 and is given by the output current reference I1* of the first converter stage 1 and a measured link voltage value V3′. The link power reference P3* is provided by a multiplier 765, for example. The link power reference P3* can be positive, indicating that power is received at the link nodes 33, 34 by the link circuit 3, or negative, indicating that power is provided to the link nodes by the link circuit 3.

The elements of the auxiliary voltage controller 76 explained so far are independent of the specific implementation of the auxiliary voltage regulator 7. That is, in each case, the power reference P7*, which represents the desired power received at the supply nodes 33, 34, may be calculated and the power P7 may be regulated accordingly.

In the example illustrated in FIG. 22, the switch half-bridge 74 is operated in a phase-shift modulated (PSM) fashion. This may include operating the first and second electronic switches 741, 742 in a complementary fashion at a fixed frequency and a fixed duty cycle of 50% (actually slightly less than 50% in order to avoid across current). The operating frequency at least approximately equals the frequency of the alternating voltage V41 provided at the supply nodes 33, 34. Furthermore, by adjusting a phase shift between the alternating voltage V41 and the switched mode operation of the switch half-bridge 74 the power P7 at the supply nodes 33, 34 can be adjusted.

For this, the auxiliary voltage controller 76 includes a phase shift calculator 766 that receives the power reference P7*, the measured auxiliary voltage value Vh′ and the measured output voltage Vo′ and provides a phase shift value q that represents the desired phase shift between the alternating voltage V41 and the switched mode operation of the switch half-bridge 74. A phase shift modulator 767 receives the phase shift value q and generates the control signals S741, S742 for controlling operation of the first and second electronic switches 741, 742 in the switch half-bridge 74 accordingly.

Referring to the above, the link circuit 3 is coupled to the second converter stage 2, so that a power transfer can take place that enables the voltage regulator 6 to maintain the auxiliary voltage Vh at the desired voltage level. Referring to the above, the link circuit 3 being coupled to the second converter stage 2 may include that the link circuit 3 is coupled to internal circuit nodes of the second converter stage 2. In this example, power transfer takes place between the link circuit 3 and the second converter stage 2. The link circuit 3 being coupled to the second converter stage 2 may also include that the link circuit 3 is coupled to the output nodes 24, 25 of the second converter stage 2. In this example, the link circuit 3 bypasses the second converter stage 2 and power transfer takes place between the link circuit 3 and the output of the power converter. Examples for both coupling the link circuit 3 to internal circuit nodes of the converter stage 2, and coupling the link circuit 3 to the output nodes 24, 25 of the second converter stage 2 are explained in the following.

The power converter explained hereinabove includes the first and second converter stages 1, 2 and the link circuit 3. For the following reasons, the power converter is highly efficient.

Referring to the above, the first converter stage 1 only has limited regulation capabilities, so that the first converter stage 1 is only capable of achieving the desired PFC functionality in combination with the link circuit 3. This, however, makes it possible to operate the first converter stage 1 in a very efficient way such that only two electronic switches operate in a switched mode at the same time (as compared to six electronic switches in a conventional PFC stage), which helps to reduce switching losses. The electronic switches that operate in the switched mode are switches 162, 163 in the example according to FIG. 7 and the electronic switches of the intermediate half-bridge in the example illustrated in FIG. 12.

Furthermore, by operating the second converter stage 2 at an essentially fixed switching frequency, resulting in a fixed voltage transfer ratio, a high efficiency of the second converter stage 2 can be achieved.

The link circuit 3 includes electronic switches that are operated in a switched mode. The link circuit 3, however, only processes a small portion of the overall power of the power converter and can be implemented with electronic switches having a lower voltage blocking capability than the electronic switches in the first and second converter stages 1, 2. Usually, the on-resistance of an electronic switch increases with the voltage blocking capability. The power losses that occur in the link circuit 3 are lower than additional power losses that would occur when implementing the first converter stage 1 as a conventional PFC stage and implementing the second converter stage 2 with an output voltage regulation capability.

FIG. 24 illustrates an example in which the link circuit 3 is coupled to internal circuit nodes of the second converter stage 2. In this example, the link circuit 3 is coupled to the transformer 260 in the resonant circuit 26 of the second converter stage 2. For this, the coupling circuit 4 includes an auxiliary winding 41 of the transformer 260, wherein the auxiliary winding 41 is inductively coupled to the first winding 268 and the second winding 269 of the transformer 260. The auxiliary winding 41 is connected to the supply nodes 33, 34 of the link circuit 3, so that a voltage V41 across the auxiliary winding 41 is provided to the supply nodes 33, 34 of the link circuit 3. In this example, the link circuit 3 is inductively coupled to internal circuit nodes of the second converter stage 2, wherein the internal circuit nodes are circuit nodes of the first winding 268 or the second winding 269. The frequency of the alternating supply voltage V41 equals the frequency of the alternating voltage V26 provided to the resonant circuit 26.

FIG. 25 illustrates one example, in which the link circuit 3 is coupled to the output nodes 24, 25 of the second converter stage 2. In this example, the coupling circuit 4 receives the output voltage Vo of the power converter and is configured to generate the alternating supply voltage V41 based on the output voltage Vo. For this, the coupling circuit 4 includes an inverter 42 and a transformer 42 with a first winding 421 connected to the inverter 42 and a second winding 422 connected to the supply nodes 33, 34 of the link circuit 3. The first winding 421 and the second winding 422 are inductively coupled. The inverter 42 is configured to generate an alternating voltage across the first winding 421 based on the output voltage Vo. An alternating voltage V422 across the second winding, which results from the alternating voltage across the first winding 421, is provided to the supply nodes 33, 34 of the link circuit 3 as the alternating voltage V41 explained herein before. In this example, the alternating voltage V41 and the supply nodes 33, 34 can have a frequency different from the frequency of the alternating voltage V26 internally generated in the second converter stage 2.

In each of the examples illustrated in FIGS. 24 and 25, the supply nodes 33, 34 of the link circuit are galvanically isolated from the second converter stage 2 by the coupling circuit 4.

In the example explained herein before, the power converter includes one second converter stage 2. This, however, is only an example. According to another example, the power converter includes two or more second converter stages that have their inputs connected in series and connected in series with the link nodes of at least one link circuit and that have their outputs connected in parallel. Two different examples of this type of power converter are illustrated in FIGS. 26 and 28. In each of the examples, only the second converter stages and the links circuits are illustrated. The first converter stage 1 is omitted and only the output nodes 12, 13 of the first converter stage 1 are shown. The first converter stage 1 providing the pulsating output voltage V1 can be implemented in accordance with any of the examples explained herein before.

In the example illustrated in FIG. 26, the power converter includes two second converter stages 2i, 2ii that have their inputs 21i, 22i, 21ii, 22ii connected in series and connected in series with the link nodes 31, 31 of the link circuit 3. Outputs 24i, 25i, 24ii, 25ii of the second converter stages 2i, 2ii are connected in parallel to form the output 24, 25 of the power converter. In in the way explained herein before, the link circuit 3 is configured to regulate the output voltage Vo of the power converter and the output current I1 of the first converter stage in order to adjust an input voltage V2 received by the series circuit of the second converter stages 2i, 2ii. According to one example, the converter stages 2i, 2ii are implemented and operated in the same way, so that each of the converter stages 2i, 2ii receives 50% of the overall input voltage V2. By connecting two (or more) second converter stages 2i, 2ii such that the inputs are connected series and the outputs are connected in parallel, the voltage level of the output voltage Vo can be reduced to 50% (or less) as compared to a power converter including only one second converter stage of the same type as the second converter stages 2i, 2ii connected in series. The link circuit 3 is coupled to the output 24, 25 for example.

In the example illustrated in FIG. 26, the combination with the second converter stages 2i, 2ii, the link circuit 3 and the coupler 4 provides a power converter module MDA.

According to one example illustrated in FIG. 27, the power converter includes several power converter modules MDA_1, MDA_2, MDA_N of the type illustrated in FIG. 26 each having an input and an output. The power converter modules are connected in parallel. That is, the power converter modules MDA_1, MDA_2, MDA_N have their inputs connected in parallel to receive the output voltage V1 of the first converter stage 1, and have their outputs connected in parallel so that each of the power converter modules MDA_1, MDA_2, MDA_N provides the output voltage Vo.

In the example illustrated in FIG. 26, the power converter includes two second converter stages 2j, 2jj and two second link circuits 3j, 3jj that have their inputs connected in series and which regulate the output current I1 of the first converter stage in common. Furthermore, outputs of the converter stages 2j, 2jj are connected in parallel.

In the example illustrated in FIG. 28, the combination with the second converter stages 2j, 2jj, the link circuits 3j, 3jj and the couplers 4j, 4jj provides a power converter module MDB.

According to one example illustrated in FIG. 29, the power converter includes several power converter modules MDB_1, MDB_2, MDB_N of the type illustrated in FIG. 28 each having an input and an output. The power converter modules are connected in parallel. That is, the power converter modules MDB_1, MDB_2, MDB_N have their inputs connected in parallel to receive the output voltage V1 of the first converter stage 1, and have their outputs connected in parallel so that each of the power converter modules MDB_1, MDB_2, MDB_N provides the output voltage Vo.

Some of the examples explained above are briefly summarized in the following with reference to numbered examples.

Example 1. A power converter, including: a first converter stage configured to receive three alternating input voltages at input nodes and provide a pulsating output voltage at an output; a second converter stage configured to receive an input voltage at an input and provide an output voltage at an output; and a link circuit including a link coupled between the output of the first converter stage and the input of the second converter stage, and supply nodes coupled to the second converter stage, wherein the link circuit is configured to regulate the output current of the first converter stage and regulate an output voltage at the output of the second converter stage.

Example 2. The power converter of example 1, wherein the second converter stage is unregulated and configured to generate the output voltage to be at least approximately proportional to the input voltage.

Example 3. The power converter of example 2, wherein the second converter stage includes a resonant converter.

Example 4. The power converter of example 3, wherein the resonant converter is an LLC converter.

Example 5. The power converter of any one of examples 1 to 4, wherein the first converter stage is configured to generate the pulsating output voltage such that the pulsating output voltage is at least approximately equal to a difference between a maximum input voltage and a minimum input voltage, wherein the maximum input voltage is that one of the three input voltages instantaneously having the highest voltage level, and wherein the minimum input voltage is that one of the three input voltages instantaneously having the lowest voltage level.

Example 6. The power converter of example 5, wherein the first converter stage is further configured to regulate the input current at that one of the input nodes that receives an intermediate voltage, wherein the intermediate voltage is that one of the three input voltages having a voltage level between the voltage levels of the highest input voltage and the lowest input voltage.

Example 7. The power converter of example 5 or 6, wherein the first converter stage includes: a rectifier connected between each of the input nodes and the output of the first converter stage; a selection circuit connected to each of the input nodes; and a current control circuit connected between the selection circuit and the output of first converter stage, wherein the selection circuit is configured to connect the current control circuit to one of the input nodes.

Example 8. The power converter of example 7, wherein the rectifier includes passive rectifier elements.

Example 9. The power converter of example 7, wherein the rectifier includes active rectifier elements.

Example 10. The power converter of example 5 or 6, wherein the first converter stage includes: inductors each connected to a respective one of the input nodes; and switch half-bridges each connected between a respective one of the inductors and the output of the first converter stage.

Example 11. The power converter of any one of examples 1 to 10, wherein the link circuit includes: a voltage and current regulator connected to the link nodes, configured to receive an auxiliary voltage, and configured to regulate the output current of the first converter stage and the output voltage of the second converter stage.

Example 12. The power converter of example 11, wherein the link circuit further includes: an auxiliary voltage regulator connected to the supply nodes of the link circuit and configured to provide the auxiliary voltage.

Example 13. The power converter of example 12, wherein the auxiliary voltage regulator is configured to provide for a bidirectional power flow.

Example 14. The power converter of any one of examples 1 to 13, wherein the supply nodes of the link circuit are coupled to internal circuit nodes of the second converter stage.

Example 15. The power converter of example 14, wherein the second converter stage includes a transformer, and wherein the supply nodes of the link circuit are coupled to circuit nodes of the transformer of the second converter stage.

Example 16. The power converter of any one of examples 1 to 15, wherein the supply nodes of the link circuit are coupled to the output of the second converter stage.

Example 17. The power converter of any one of examples 1 to 16, wherein the supply nodes of the link circuit are coupled to the second converter stage through a coupling circuit.

Example 18. The power converter of example 17, wherein the coupling circuit provides for a galvanic isolation between the supply nodes of the link circuit and the second converter stage.

Example 19. The power converter of any one of examples 1 to 18, wherein the second converter stage is a first second converter stage; and wherein the power converter further includes at least one further second converter stage having an input connected in series with the input of the first second converter stage and having an output connected in parallel with the output of the first second converter stage.

Example 20. The power converter of example 19, wherein the link circuit is a first link circuit; and wherein the power converter further includes at least one further link circuit.

Example 21. A method, including: regulating an output current of a first converter stage and regulating an output voltage at the output of a second converter stage by a link circuit in a power converter, wherein the power converter includes: a first converter stage configured to receive three alternating input voltages at input nodes and provide a pulsating output voltage at an output; a second converter stage configured to receive an input voltage at an input and provide an output voltage at an output; and a link circuit including a link coupled between the output of the first converter stage and the input of the second converter stage, and supply nodes coupled to the second converter stage.

Example 22. A control circuit configured to control operation of a link circuit in a power converter such that the link circuit regulates an output current of a first converter stage and regulates an output voltage at an output of a second converter stage, wherein the power converter, including: the first converter stage configured to receive three alternating input voltages at input nodes and provide a pulsating output voltage at an output; the second converter stage configured to receive an input voltage at an input and provide the output voltage at the output; and the link circuit including a link coupled between the output of the first converter stage and the input of the second converter stage, and supply nodes coupled to the second converter stage.

1. A power converter, comprising:
a first converter stage (1) configured to receive three alternating input voltages (Va, Vb, Vc) at input nodes (11a, 11b, 11c) and provide a pulsating output voltage (V1) at an output (12, 13);
a second converter stage (2) configured to receive an input voltage (V2) at an input (22, 23) and provide an output voltage (Vo) at an output (24, 25); and
a link circuit (3) comprising a link (31, 32) coupled between the output (12, 13) of the first converter stage (1) and the input (22, 23) of the second converter stage (2), and supply nodes (33, 34) coupled to the second converter stage (2),
wherein the link circuit (3) is configured to regulate the output current (11) of the first converter stage (1) and regulate an output voltage (Vo) at the output of the second converter stage (2).

2. The power converter of claim 1,
wherein the second converter stage (2) is unregulated and configured to generate the output voltage (Vo) to be at least approximately proportional to the input voltage (V2).

3. The power converter of claim 2,
wherein the second converter stage (2) comprises a resonant converter.

4. The power converter of claim 3,
wherein the resonant converter is an LLC converter.

5. The power converter of any one of claims 1 to 4,
wherein the first converter stage (1) is configured to generate the pulsating output voltage (V1) such that the pulsating output voltage (V1) is at least approximately equal to a difference between a maximum input voltage (Vmax) and a minimum input voltage (Vmin),
wherein the maximum input voltage (Vmax) is that one of the three input voltages (Va, Vb, Vc) instantaneously having the highest voltage level, and
wherein the minimum input voltage (Vmin) is that one of the three input voltages (Va, Vb, Vc) instantaneously having the lowest voltage level.

6. The power converter of claim 5,
wherein the first converter stage (1) is further configured to regulate the input current at that one of the input nodes (11a, 11b, 11c) that receives an intermediate voltage (Vint),
wherein the intermediate voltage (Vint) is that one of the three input voltages (Va, Vb, Vc) having a voltage level between the voltage levels of the highest input voltage (Vmax) and the lowest input voltage (Vmin).

7. The power converter of claim 5 or 6, wherein the first converter stage (1) comprises:
a rectifier (14) connected between each of the input nodes (11a, 11b, 11c) and the output (12, 23) of the first converter stage (1);
a selection circuit (15) connected to each of the input nodes (11, 11b, 11c); and
a current control circuit (16) connected between the selection circuit (15) and the output (12, 13) of first converter stage (1),
wherein the selection circuit (15) is configured to connect the current control circuit (16) to one of the input nodes (11a, 11b, 11c).

8. The power converter of claim 7,
wherein the rectifier (14) comprises passive rectifier elements (141a-142c).

9. The power converter of claim 7,
wherein the rectifier (14) comprises active rectifier elements (141, 142).

10. The power converter of claim 5 or 6, wherein the first converter stage (1) comprises:
inductors (17a, 17b, 17c) each connected to a respective one of the input nodes (11a, 11b, 11c); and
switch half-bridges each connected between a respective one of the inductors (17a, 17b, 17c) and the output (12, 13) of the first converter stage (1).

11. The power converter of any one of claims 1 to 10, wherein the link circuit (3) comprises:
a voltage and current regulator (6) connected to the link nodes (31, 32), configured to receive an auxiliary voltage (Vh), and configured to regulate the output current (I1) of the first converter stage (1) and the output voltage (Vo) of the second converter stage (2).

12. The power converter of claim 11, wherein the link circuit (3) further comprises:
an auxiliary voltage regulator (7) connected to the supply nodes (33, 34) of the link circuit (3) and configured to provide the auxiliary voltage (Vh).

13. The power converter of claim 12,
wherein the auxiliary voltage regulator (7) is configured to provide for a bidirectional power flow.

14. The power converter of any one of claims 1 to 13,
wherein the supply nodes (33, 34) of the link circuit (3) are coupled to internal circuit nodes of the second converter stage (2).

15. The power converter of claim 14,
wherein the second converter stage (2) comprises a transformer (260), and
wherein the supply nodes (33, 34) of the link circuit (3) are coupled to circuit nodes of the transformer of the second converter stage (2).

16. The power converter of any one of claims 1 to 15,
wherein the supply nodes (33, 34) of the link circuit (3) are coupled to the output (23, 24) of the second converter stage (2).

17. The power converter of any one of claims 1 to 16,
wherein the supply nodes (33, 34) of the link circuit (3) are coupled to the second converter stage through a coupling circuit (4).

18. The power converter of claim 17,
wherein the coupling circuit (4) provides for a galvanic isolation between the supply nodes (33, 34) of the link circuit (3) and the second converter stage (2).

19. The power converter of any one of claims 1 to 18,
wherein the second converter stage is a first second converter stage (2i; 2j); and
wherein the power converter further comprises at least one further second converter stage (2ii; 2jj) having an input connected in series with the input of the first second converter stage (2i; 2j) and having an output connected in parallel with the output of the first second converter stage (2i; 2j).

20. The power converter of claim 19,
wherein the link circuit is a first link circuit (3j); and
wherein the power converter further comprises at least one further link circuit (3jj).

21. A method, comprising:
regulating an output current (11) of a first converter stage (1) and regulating an output voltage (Vo) at the output of a second converter stage (2) by a link circuit (3) in a power converter,
wherein the power converter comprises:
a first converter stage (1) configured to receive three alternating input voltages (Va, Vb, Vc) at input nodes (11a, 11b, 11c) and provide a pulsating output voltage (V1) at an output (12, 13);
a second converter stage (2) configured to receive an input voltage (V2) at an input (22, 23) and provide an output voltage (Vo) at an output (24, 25); and
a link circuit (3) comprising a link (31, 32) coupled between the output (12, 13) of the first converter stage (1) and the input (22, 23) of the second converter stage (2), and supply nodes (33, 34) coupled to the second converter stage (2).

22. A control circuit (66) configured to control operation of a link circuit (3) in a power converter such that the link circuit (3) regulates an output current (11) of a first converter stage (1) and regulates an output voltage (Vo) at an output of a second converter stage (2),
wherein the power converter, comprising:
the first converter stage (1) configured to receive three alternating input voltages (Va, Vb, Vc) at input nodes (11a, 11b, 11c) and provide a pulsating output voltage (V1) at an output (12, 13);
the second converter stage (2) configured to receive an input voltage (V2) at an input (22, 23) and provide the output voltage (Vo) at the output (24, 25); and
the link circuit (3) comprising a link (31, 32) coupled between the output (12, 13) of the first converter stage (1) and the input (22, 23) of the second converter stage (2), and supply nodes (33, 34) coupled to the second converter stage (2).
